(19) United States
(12) Patent Application Publication
(10) Pub. No.: US 2024/0302183 A1
(43) Pub. Date: Sep. 12, 2024

(54) METHOD AND SYSTEM FOR CROWDSOURCED CREATION OF MAGNETIC MAP

(71) Applicant: INVENSENSE, INC, San Jose, CA (US)

(72) Inventors: Gennadii Berkovich, Calgary (CA); Dmitri Churikov, Calgary (CA); Chris Goodall, Calgary (CA); Jacques Georgry, Calgary (CA); Abdelrahman Ali, Calgary (CA)

(21) Appl. No.: 18/596,233

(22) Filed: Mar. 5, 2024

Related U.S. Application Data
(60) Provisional application No. 63/450,632, filed on Mar. 7, 2023.

(51) Int. Cl. G01C 21/00

(52) U.S. Cl. CPC G01C 21/3841; G01C 21/3807; G01C 21/3848

(57) ABSTRACT

Systems and methods are disclosed for creating a magnetic map by obtaining magnetic field measurements from a plurality of platforms. A first set of poses for each platform is determined and information from the magnetic map is obtained for any existing magnetic field values for the first set. Magnetic constraints on poses of the platform are determined and used for determining a second set of poses for each platform. The magnetic field values of the magnetic map are then updated based at least in part on the second set of poses for each platform.

### CROSS-REFERENCE TO RELATED APPLICATIONS

This application claims priority from and benefit of U.S. Provisional Patent Application Ser. No. 63/450,632, filed Mar. 7, 2023, which is entitled “Crowdsourced Creation of Magnetic Map,” is assigned to the assignee hereof, and is incorporated by reference in its entirety.

### FIELD OF THE PRESENT DISCLOSURE

The present disclosure relates to positioning of people, vehicles and goods within indoor or outdoor environments. More specifically, systems and methods are provided for creating magnetic maps that may be used for navigation.

### BACKGROUND

A variety of technologies have been developed to help determine position information for moving platforms, such as autonomous or piloted ground or aerial vehicles like cars, electric bikes and scooters (eBikes and eScooters), robots, and other types of vehicles. A pedestrian is also considered a moving platform. For example, the Global Navigation Satellite Systems (GNSS) comprises a group of satellites that transmit encoded signals and receivers on the ground, by means of trilateration techniques, can calculate their position using the travel time of the satellites' signals and information about the satellites' current location. GNSS is considered a reference-based technique and provides an absolute source of navigational information and includes without limitation the Global Positioning System (GPS), the Global Navigation Satellite System (GLONASS), Galileo and/or BeiDou. Alternatively or in addition, other types of absolute navigational information depending on information from external sources may include WiFi™ positioning, cellular tower positioning, Bluetooth™ positioning beacons or other similar methods. The desirability of obtaining position information extends to indoor environments where pedestrians may traverse and multiple types of vehicles may be employed, including forklifts and other service machinery in a warehouse, automobiles and buses in underground parking structures, wheelchairs in a hospital, and portable robots or unmanned aerial vehicles (UAV)/drones that navigate within buildings. However, GNSS is typically unsatisfactory when used for indoor positioning due to the attenuation of satellite signals in the walls and roofs buildings or when the outdoor environment interferes, such as in urban canyons, necessitating use of different technologies.

In the absence of GNSS signals, an Inertial Navigation System (INS) may be used by employing techniques such as dead reckoning to help determine position. INS is a self-contained and/or “non-reference based” technique that utilizes inertial sensors within the moving object and do not depend upon external sources of information that can become interrupted or blocked. Motion sensors are self-contained within the moving object and measure motion, such as through the use of gyroscopes to measure the object's rate of rotation/angle and accelerometers to measure the object's specific force (from which acceleration is obtained). Using initial estimates of position, velocity and orientation angles of the moving object as a starting point, the INS readings can subsequently be integrated over time and used to determine a navigation solution. Typically, measurements are integrated (mathematical integration which is a calculus operation) once for gyroscopes to yield orientation angles and twice for accelerometers to yield position of the moving object incorporating the orientation angles. Thus, sensor measurements will undergo a triple integration operation during the process of yielding position. Integrated navigation techniques usually integrate (i.e. combine) reference-based or absolute navigational information with self-contained or non-reference-based navigation information. Integrated navigation techniques may employ state estimation techniques, such as a Kalman filter, an extended Kalman filter, a Gaussian sum filter, an unscented filter, a particle filter, or others, which have characteristics including a prediction phase and an update phase (which may also be termed a measurement update phase). Absolute navigational information in the measurement domain may be integrated with the state estimation technique in a tightly coupled architecture or absolute navigational information in the position/velocity domain may be integrated with the state estimation technique in a loosely coupled architecture. A state estimation technique also uses a system model and measurement model(s) based on what measurements are used. The system model is used in the prediction phase, and the measurement model(s) is/are used in the update phase.

Due to the integration operations (the mathematical integration as in calculus), motion sensor-based techniques may fail to provide adequate performance by themselves, particularly over longer durations due to significant performance degradation from accumulating sensor drifts and bias. As such, positioning technologies relying solely on motion sensors may not satisfy all requirements for seamless indoor navigation applications. As a result, alternative positioning techniques that can provide strong coverage in areas where access to GNSS and other reference-based positioning is degraded or denied are desirable.

State-of-the-art solutions for challenging GNSS conditions are mostly based on fusion of GNSS and motion data with the data provided by camera-based, radar-based, or lidar-based technologies. However, equipping platforms with such devices can be costly and/or difficult due to limitations on design. Moreover, performance may be degraded in rain, snow, and other environmental conditions and power consumption may also be an issue for some types of platforms.

Another class of techniques that may be used to compensate for degraded GNSS availability is known as “fingerprinting,” and relies on recording patterns of electromagnetic signals at known locations within an area for which position information may be desired. When a device subsequently measures a pattern of received signals that is correlated with a known location, that location may be used to determine the position of the device and/or to aid another positioning technique, such as through integration with the INS techniques noted above. Suitable examples of signals that may be used for fingerprinting may be based on the wireless signals for an IEEE 802.11 Wireless Local Area Network (WLAN), commonly referred to as “WiFi,” other wireless communication signals such as Bluetooth™ and/or radiofrequency identification (RFID) signals.

Importantly, environmental electromagnetic signals such as magnetic fields can also provide the necessary fingerprints and benefit from the techniques of this disclosure. Notably, magnetic-based positioning relies on variations in the Earth magnetic field created by natural phenomena or by human activity, such as the use of ferrous materials in building construction and in dense urban areas. As such, it would be desirable to create a map of magnetic anomalies in such outdoor areas like urban canyons, construction sites, and combined outdoor and indoor areas like buildings, tunnels or underground parking garages with adjacent streets to enable positioning based on magnetic fields. All such areas feature challenging conditions of GNSS positioning in which satellite signals outdoors are affected by multipath and obstruction (so called non line of site or NLOS situation) or attenuates indoors so that GNSS positioning accuracy drastically degrades. Magnetic-based positioning is an attractive positioning technology in challenging GNSS conditions because it is infrastructure-free and benefits from the long-term stability of magnetic fields. A magnetometer is a small and cheap device that consumes low power and can be easily added to the equipment of a platform or a device conveyed by the platform. Accordingly, the techniques of this disclosure may be employed to create a magnetic map of an area, particularly using crowd-sourcing to facilitate gathering the necessary magnetic field measurements.

### SUMMARY

As will be described in detail below, this disclosure includes a method for building a magnetic map of an area. The area may be a plurality of positions and the magnetic map includes magnetic field values for the positions. The method involves obtaining magnetic field measurements from at least one magnetometer associated with each of a plurality of platforms traversing at least a portion of the area, available absolute navigational information and motion sensor data from a sensor assembly associated with each platform. Next, the absolute navigational information and motion sensor data is employed to determine a first set of poses for each platform. Information from the magnetic map for any existing magnetic field values for the first set of the poses is also obtained. Then, magnetic constraints on poses of the platform are determined based at least in part on the obtained magnetic map information and the obtained magnetic field measurements. Subsequently, a second set of poses for each platform are determined based at least in part on the determined magnetic constraints, the obtained magnetic field measurements, absolute navigational information and motion sensor data. The magnetic field values of the magnetic map are then updated based at least in part on the second set of poses for each platform.

This disclosure also includes a system for building a magnetic map of an area, wherein the area comprises a plurality of positions and wherein the magnetic map comprises magnetic field values for the positions. The system may include a plurality of platforms traversing at least a portion of the area, wherein each platform is configured to provide magnetic field measurements from at least one magnetometer associated with each platform, available absolute navigational information, and motion sensor data from a sensor assembly associated with each platform, at least one remote memory to store the magnetic map and at least one remote processor operative to obtain a determined a first set of poses for each platform, wherein the first set of poses is determined by employing the absolute navigational information and motion sensor data, obtain information from the magnetic map for any existing magnetic field values for the first set of poses, determine magnetic constraints on poses of the platform based at least in part on the obtained magnetic map information and the obtained magnetic field measurements, obtain a second set of poses for each platform based at least in part on determined magnetic constraints, obtained magnetic field measurements, absolute navigational information and motion sensor data and update the magnetic field values of the magnetic map based at least in part on the second set of poses for each platform.

Further, this disclosure also includes a non-transitory computer readable storage medium with instructions embodied thereon for causing at least one processor to perform a method for building a magnetic map of an area, wherein the area comprises a plurality of positions and wherein the magnetic map comprises magnetic field values for the positions. The method performed by the at least one processor may involve obtaining a determined a first set of poses for a plurality of platforms traversing at least a portion of the area each platform, wherein each platform is configured to provide magnetic field measurements from at least one magnetometer associated with each platform, available absolute navigational information, and motion sensor data from a sensor assembly associated with each platform and wherein the first set of poses is determined by employing the absolute navigational information and motion sensor data, obtaining information from the magnetic map for any existing magnetic field values for the first set of poses, determining magnetic constraints on poses of the platform based at least in part on the obtained magnetic map information and the obtained magnetic field measurements, obtaining a second set of poses for each platform based at least in part on determined magnetic constraints, the obtained magnetic field measurements, absolute navigational information and motion sensor data and updating the magnetic field values of the magnetic map based at least in part on the second set of poses for each platform.

### BRIEF DESCRIPTION OF THE DRAWINGS

FIG. 1 is a schematic diagram of building a magnetic map using information from a plurality of platforms according to an embodiment.

FIG. 2 is schematic diagram of a representative routine for of building a magnetic map using information from a plurality of platforms according to an embodiment.

FIG. 3 is a schematic diagram showing three platforms obtaining magnetic field measurements in an area during the building of a magnetic map according to an embodiment.

FIG. 4a is a schematic diagram showing an example of the magnetic map in a coordinate frame according to an embodiment.

FIG. 4b is a schematic diagram showing an example of orientation angles for a platform in the coordinate frame of FIG. 4a according to an embodiment.

FIG. 5a is a schematic diagram showing an example of the relationship between the coordinate frame and platform frame for a bicycle according to an embodiment.

FIG. 5b is a schematic diagram showing examples of the relationship between coordinate frames and platform frames for a pedestrian and a vehicle according to an embodiment.

FIG. 6 is a schematic diagram showing determination of a first set of poses for a platform according to an embodiment.

FIG. 7 is a schematic diagram showing obtaining a part of the magnetic map for the first set of platform poses according to an embodiment.

FIG. 8 is a schematic diagram showing the determination of magnetic constraints on platform poses according to an embodiment.

FIGS. 9a and 9b are schematic diagrams showing impact of magnetic anomalies on magnetic heading according to an embodiment.

FIG. 10 is a schematic diagram showing determination of a second set of poses for a platform according to an embodiment.

FIGS. 11a and 11b are schematic diagrams showing a robust estimation procedure for determining magnetic field values according to an embodiment.

FIGS. 12a, 12b and 12c are schematic diagrams showing the effect of employing an increasing number of datasets when estimating magnetic field values according to an embodiment.

FIG. 13 is a schematic diagram showing a 3D plot of a map of magnetic anomalies after estimation according to an embodiment.

FIG. 14 is a schematic diagram comparing availability of absolute navigational information for two platforms according to an embodiment.

FIG. 15 is a schematic diagram showing determination of a second set of poses for a platform when absolute navigational information is only partially available according to an embodiment.

FIGS. 16a, 16b and 16c are schematic diagrams showing the effect of employing an increasing number of datasets when estimating magnetic field values according to an embodiment.

FIGS. 17a, 17b and 17c are schematic diagrams showing platforms with magnetometers installed at different heights and the corresponding magnetic field map according to an embodiment.

### DETAILED DESCRIPTION

At the outset, it is to be understood that this disclosure is not limited to particularly exemplified materials, architectures, routines, methods, or structures as such may vary. Thus, although a number of such options, similar or equivalent to those described herein, can be used in the practice or embodiments of this disclosure, the preferred materials and methods are described herein.

It is also to be understood that the terminology used herein is for the purpose of describing particular embodiments of this disclosure only and is not intended to be limiting. It is also to be understood that terms of art as used herein are to be given their accepted meanings known to one of ordinary skill in the art. Where appropriate, terms may also be given explicit definitions in the specification to convey their intended meaning.

For purposes of convenience and clarity only, directional terms, such as top, bottom, left, right, up, down, over, above, below, beneath, rear, back, and front, may be used with respect to the accompanying drawings or chip embodiments. These and similar directional terms should not be construed to limit the scope of the disclosure in any manner.

In this specification and in the claims, it will be understood that when an element is referred to as being “connected to” or “coupled to” another element, it can be directly connected or coupled to the other element or intervening elements may be present. In contrast, when an element is referred to as being “directly connected to” or “directly coupled to” another element, there are no intervening elements present.

Some portions of the detailed descriptions which follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the exemplary wireless communications devices may include components other than those shown, including well-known components such as a processor, memory and the like.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, performs one or more of the methods described above. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor. For example, a carrier wave may be employed to carry computer-readable electronic data such as those used in transmitting and receiving electronic mail or in accessing a network such as the Internet or a local area network (LAN). Of course, many modifications may be made to this configuration without departing from the scope or spirit of the claimed subject matter.

The various illustrative logical blocks, modules, circuits and instructions described in connection with the embodiments disclosed herein may be executed by one or more processors, such as one or more motion processing units (SPUs), digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structure or any other structure suitable for implementation of the techniques described herein. In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a combination of an SPU and a microprocessor, a plurality of microprocessors, one or more microprocessors in conjunction with an SPU core, or any other such configuration.

Unless defined otherwise, all technical and scientific terms used herein have the same meaning as commonly understood by one having ordinary skill in the art to which the disclosure pertains.

Finally, as used in this specification and the appended claims, the singular forms “a, “an” and “the” include plural referents unless the content clearly dictates otherwise.

According to the techniques of this disclosure, systems and methods are provided for enabling magnetic-based positioning techniques by creating a magnetic map for an area. In one aspect, these techniques may replace the laborious regular survey of magnetic fields using crowdsourcing, such that the measurements and data for mapping are collected by multiple platforms moving across the area in overlapping routes. The information may also be collected using portable devices, such as smart phones or the like, that are transported by different platforms, including pedestrians and vehicles of different type like normal bikes, electrical bikes and scooters, cars, etc. During the information gathering process, information already collected may be used to improve accuracy of the mapping. This disclosure also provides techniques to address the problem of ambiguity in the magnetic field, in which the same values of magnetic field can happen in different locations. These techniques also accommodate measurements collected from the magnetometers that are at different positions relative to the platform given that the magnetic field depends on height and not only on 2D position.

Magnetic-based positioning uses variations of Earth magnetic field created by ferrous materials of buildings construction and in dense urban areas. As noted above, magnetic-based positioning is an attractive technology for indoor and outdoor positioning in an urban environment because it is infrastructure-free and due to long-term stability of magnetic field inside buildings. A first stage of magnetic-based positioning is a two-stage process is creating the magnetic fingerprint map that represents magnetic field of the venue. Creating such a map requires collecting magnetometer readings throughout the area covered by the map. Examples of approaches for creating magnetic fingerprint maps are detailed in commonly-owned U.S. Pat. Nos. 10,341,982, 11,035,915, and U.S. patent application Ser. No. 17/512,301, each of which is incorporated by reference in the entirety.

Tracking the position of platforms according to this disclosure also involves the use of motion sensor data as may be obtained from one or more sensor assemblies representing motion of platform in space, and may include a portable device conveyed by the platform, comprising inertial sensors such as an accelerometer and a gyroscope and may be termed an inertial measurement unit (IMU), other motion sensors including a pressure sensor or others may be used in addition. Depending on the configuration, the sensors measure one or more axes of rotation and/or one or more axes of acceleration of the device. In one embodiment, this may include inertial rotational motion sensors or inertial linear motion sensors. For example, the rotational motion sensors may be gyroscopes to measure angular velocity along one or more orthogonal axes and the linear motion sensors may be accelerometers to measure linear acceleration along one or more orthogonal axes. In one aspect, three gyroscopes and three accelerometers may be employed, such that a sensor fusion operation combines data to provide a six axis determination of motion or six degrees of freedom (6DOF). As desired, one or more sensors may be implemented using Micro Electro Mechanical System (MEMS), allowing integration into a single small package, but the techniques of this disclosure may be applied to any sensor design or implementation. Exemplary details regarding suitable sensor configurations may be found in commonly-owned U.S. Pat. Nos. 8,250,921 and 8,952,832, which are hereby incorporated by reference in their entirety and implementations are available from InvenSense, Inc. of San Jose, CA. Using dead-reckoning or other suitable techniques, a position determination for the portable device may be propagated forward in time, allowing the portable device to be tracked. However, particularly over longer durations, significant performance degradation from the accumulating sensor drifts and bias may occur.

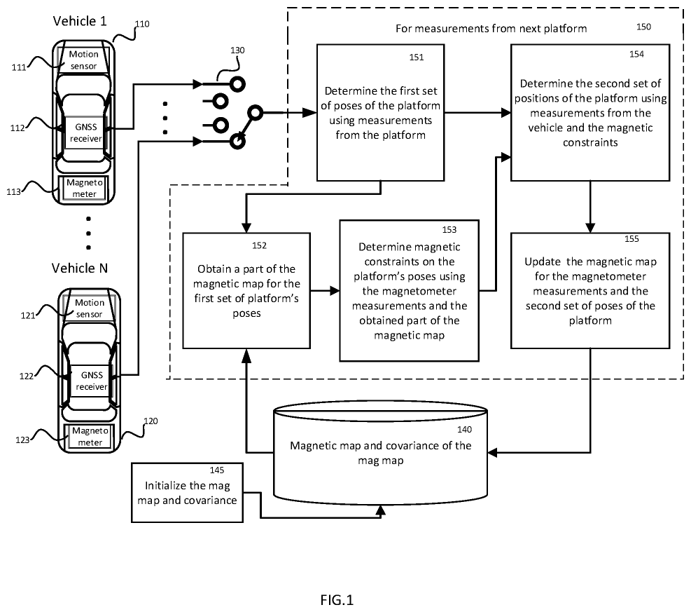

To help illustrate techniques of this disclosure, a representative example of multiple platforms moving in an area is schematically depicted in FIG. 1. Although only two vehicles 110 (Vehicle 1) and 120 (Vehicle N) are shown in the picture, any number of platforms may be used to gather the information, including up to many thousands. Each platform is equipped at least with a magnetometer (113, 123), a GNSS receiver (112, 122), and a motion sensor (111, 121), either as part of the vehicle equipment or contained in a portable device conveyed by the platform. In other embodiments, different sources of absolute navigational information may be employed. The vehicles traverse the area with overlapping trajectories and, when at the same location, provide repeating measurements of the corresponding magnetic fields. The set of data comprising measurements of these equipment (the dataset) from each platform can be sent to a server or a cloud. The server/cloud processes the datasets from the platforms individually as schematically represented by switch 130. Processing operation 150 comprises several steps as will be described in detail below, with the goal of iteratively creating the magnetic field measurements of the magnetic map 140. In some embodiments, the covariance of the magnetic map is also calculated and as such, discussion throughout this disclosure regarding magnetic field measurements may include covariance information.

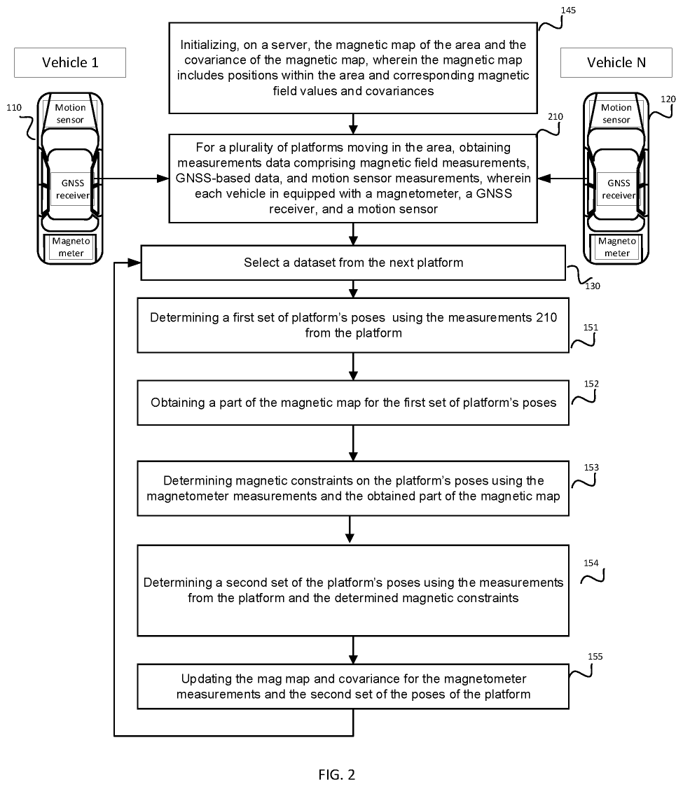

As reinforced by FIG. 2, this representative routine for crowdsource-based mapping of magnetic field in an area involves multiple operations. First, remote processing resource such as a server 150 initializes the magnetic map 140 of the area in step 145, wherein the magnetic map includes positions within the area and corresponding magnetic field values and may include covariances. Next, measurement data 210 of FIG. 2 comprising magnetic field measurements, GNSS-based data, and motion sensor measurements are obtained for a plurality of platforms, such as vehicles 110 and 120 moving in the area, and each platform is equipped with a magnetometer (113, 123), a GNSS receiver (112,122), and a motion sensor (111, 121). Then, each dataset of the measurements obtained from the platform is iteratively processed by server 150, including the operations of:
i. determining a first set of poses of each platform using the obtained measurements in step 151, which may in any embodiment also include pose covariances;
ii. obtaining a part of the magnetic map, and optionally the covariance of the magnetic map, for the first set of platform poses in step 152;
iii. determining magnetic constraints on the platform's poses using the magnetometer measurements and the obtained part of the magnetic map in step 153;
iv. determining a second set of the poses of each platform (and covariances depending on the embodiment) of the poses using the measurements from the platform and the magnetic constraints in step 154; and
v. updating the magnetic map (and optionally covariance) for the magnetometer measurements and the second set of the poses of the platform in step 155. These steps are repeated for each platform.

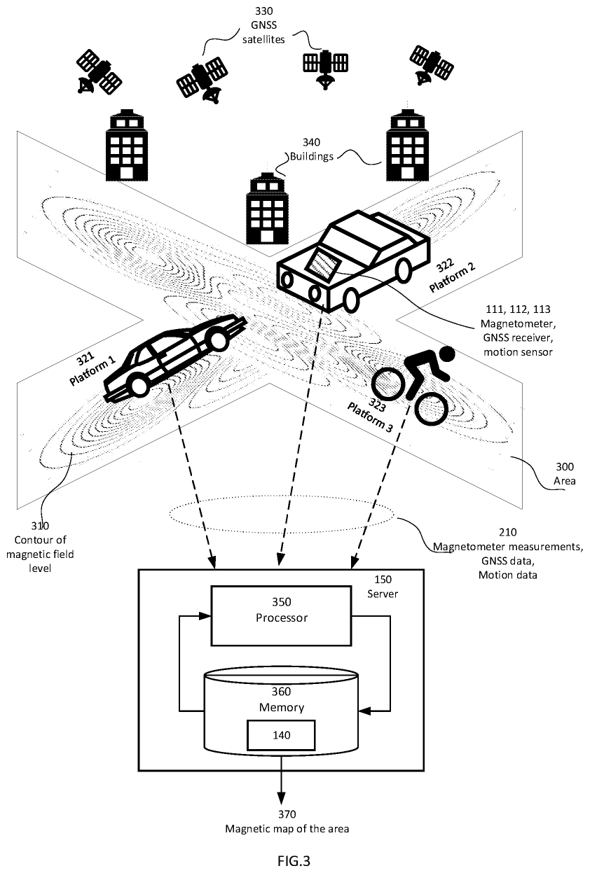

A further illustrative example is shown in FIG. 3, with three platforms of different type are shown in an outdoor area 300 like, for example, a crossroad, but there can be significantly more vehicles in the area, which can be of a different shape and size. In this example, platform 1 is a small car 321, platform 2 is a large car 322, and platform 3 is a bicycle 323. Again, each platform is equipped with a magnetometer 123, a GNSS receiver 122, and a motion sensor 121 as shown for platform 2 (322). Magnetometers of each vehicle measure ambient magnetic field, variations of which are shown by contour lines 310 in the area 300. GNSS receivers receive signals of navigation satellites 330 shown in the upper part of the FIG. 3. The buildings 340 shown may obstruct GNSS signals, an environment known as an “urban canyon.” Motion sensors determine parameters of motion for each platform. Each platform sends measured magnetic field value, received GNSS data, and motion data 210 to a server 150 using communication means not shown in the Figure. Vehicles may also send other information to the server, for example, configuration data as explained below.

Server 150 comprising at least one processor 350 and at least one memory 360 receives the data from the plurality of platforms, e.g., 321, 322, and 323. The processor 350 is configured to process the data from the vehicles as discussed above with regard to FIGS. 1 and 2. The memory 360 of server 150 stores magnetic map 140 and possibly other parameters like covariance, a history of magnetometer measurements, etc. The cyclical connections between the processor and the memory represent the iterative update of the magnetic map as noted above. The memory can also store other maps, such as other electromagnetic fingerprint maps that can be created and/or used by the processor in addition to the magnetic map. Processing can be provided either on the server or, in some embodiments, can be distributed between the server and the vehicles/platforms, which may be equipped with processors for this purpose so that at least one of the first set of poses, the second set of poses and the magnetic constraints may be determined by at least one of the platforms or by the remote processor.

As such, the created magnetic map 370 and (and other fingerprint maps of the area if employed) can be sent back to the vehicles/platforms to be used for positioning in the area. Platforms can send magnetic field measurements, absolute navigation data like GNSS-based data, and motion sensor measurements to the server. The platforms may also receive from the server the obtained part of magnetic map to support distributed processing mentioned above. To support the data interchange between platforms and the server, the platforms and server may communicate through a wireless or cellular network. Any suitable protocol, including cellular-based and wireless local area network (WLAN) technologies such as Universal Terrestrial Radio Access (UTRA), Code Division Multiple Access (CDMA) networks, Global System for Portable Communications (GSM), the Institute of Electrical and Electronics Engineers (IEEE) 802.16 (WiMAX), Long Term Evolution (LTE), IEEE 802.11 (WiFi™) and others may be employed. Communication may be direct or indirect, such as through multiple interconnected networks. As will be appreciated, a variety of systems, components, and network configurations, topologies and infrastructures, such as client/server, peer-to-peer, or hybrid architectures, may be employed to support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the techniques as described in various embodiments.

Accordingly, the techniques of this disclosure include a method for Systems and methods are disclosed for creating a magnetic map by obtaining magnetic field measurements from at least one magnetometer associated with each of a plurality of platforms traversing at least a portion of the area, available absolute navigational information and motion sensor data from a sensor assembly associated with each platform. Next, the absolute navigational information and motion sensor data is employed to determine a first set of poses for each platform. Information from the magnetic map for any existing magnetic field values for the first set is also obtained. Then, magnetic constraints on poses of the platform are determined based at least in part on the obtained magnetic map information and the obtained magnetic field measurements. Subsequently, a second set of poses for each platform are determined based at least in part on the determined magnetic constraints, the obtained magnetic field measurements, absolute navigational information and motion sensor data. The magnetic field values of the magnetic map are then updated based at least in part on the second set of poses for each platform.

In one aspect, the magnetic map further comprises covariances of the magnetic field values, further comprising updating the covariances of magnetic field values of the magnetic map based at least in part on the second set of poses for each platform.

In one aspect, determining the second set comprises matching the obtained magnetic field measurements with the obtained magnetic map information using the determined magnetic constraints. The matching includes employing consecutive magnetic field measurements.

In one aspect, determining the second set may include employing the obtained magnetic field measurements to estimate a magnetic heading for at least some of the poses using the determined magnetic constraints. Estimating the magnetic heading may also be based on the obtained magnetic map information.

At least one of the first set of poses and the second set of poses may be determined by tightly integrating the absolute navigational information.

In one aspect, updating the magnetic field values of the magnetic map may be performed recursively based at least in part on a relation between covariances of the obtained magnetic map information and the obtained magnetic field measurements.

In one aspect, updating the magnetic field values of the magnetic map may be further based on estimated uncertainties associated with the magnetic field measurements by applying a robust estimation procedure.

In one aspect, absolute navigational information may be unavailable for at least one pose for at least one of the platforms.

In one aspect, the at least one magnetometer and the sensor assembly associated with at least one of the plurality of platforms may be integrated into a portable device conveyed by the platform such that the method is operable when the portable device is constrained within the platform and when the portable device is unconstrained within the platform. The platform conveying the portable device may be at least one of a pedestrian and a vehicle.

In one aspect, the method may also involve determining a height of the magnetometer for at least one of the platforms, such that updating the magnetic map information includes the determined height.

In one aspect, the method may also involve integrating measurements from at least one of additional source of data for determination at least one of the first and second sets, wherein at least one of a plurality of platforms further comprises at least one of a wireless receiver, a camera, a lidar, and a radar, from which the measurements from the additional source of data are acquired.

In one aspect, the method may also involve creating a map of wireless signals based on received wireless signals and at least in part on the second set for each platform, wherein at least one of a plurality of platforms further comprises a wireless receiver.

In one aspect, the motion sensor data for at least one of the platforms may include information obtained from at least one of an odometry sensor, a velocity sensor and a pressure sensor.

In one aspect, the motion sensor data for at least one of the platforms may include inertial motion sensor information.

In one aspect, the method may also involve at least partially initializing the magnetic map using at least one of values from a global geomagnetic model and results of a previous mapping operation.

As noted above, this disclosure also includes a system for building a magnetic map of an area, wherein the area comprises a plurality of positions and wherein the magnetic map comprises magnetic field values for the positions. The system may include a plurality of platforms traversing at least a portion of the area, wherein each platform is configured to provide magnetic field measurements from at least one magnetometer associated with each platform, available absolute navigational information, and motion sensor data from a sensor assembly associated with each platform, at least one remote memory to store the magnetic map and at least one remote processor operative to obtain a determined a first set of poses for each platform, wherein the first set is determined by employing the absolute navigational information and motion sensor data, obtain information from the magnetic map for any existing magnetic field values for the first set, determine magnetic constraints on poses of the platform based at least in part on the obtained magnetic map information and the obtained magnetic field measurements, obtain a second set of poses for each platform based at least in part on determined magnetic constraints, the obtained magnetic field measurements, absolute navigational information and motion sensor data and update the magnetic field values of the magnetic map based at least in part on the second set of poses for each platform.

In one aspect, at least one of the first set, the second set and the magnetic constraints may be determined by at least one of the platforms.

In one aspect, at least one of the first set, the second set and the magnetic constraints may be determined by the at least one remote processor.

In one aspect, at least one of the at least one remote processor and at least one remote memory may be further configured for building and storing a map of wireless signals.

In one aspect, the at least one remote processor may be further configured to obtain a height of the magnetometer for at least one of the platforms, wherein updating the magnetic map information includes the obtained height.

In one aspect, the magnetic map may also include covariances of the magnetic field values, wherein the at least one remote processor is further configured to update the covariances of magnetic field values of the magnetic map based at least in part on the second set for each platform.

Further, this disclosure also includes a non-transitory computer readable storage medium with instructions embodied thereon for causing at least one processor to perform a method for building a magnetic map of an area, wherein the area comprises a plurality of positions and wherein the magnetic map comprises magnetic field values for the positions. The method performed by the at least one processor may involve obtaining a determined a first set of poses for a plurality of platforms traversing at least a portion of the area each platform, wherein each platform is configured to provide magnetic field measurements from at least one magnetometer associated with each platform, available absolute navigational information, and motion sensor data from a sensor assembly associated with each platform and wherein the first set is determined by employing the absolute navigational information and motion sensor data, obtaining information from the magnetic map for any existing magnetic field values for the first set, determining magnetic constraints on poses of the platform based at least in part on the obtained magnetic map information and the obtained magnetic field measurements, obtaining a second set of poses for each platform based at least in part on determined magnetic constraints, the obtained magnetic field measurements, absolute navigational information and motion sensor data and updating the magnetic field values of the magnetic map based at least in part on the second set of poses for each platform.

In one aspect, the magnetic map may also include covariances of the magnetic field values such that the method performed by the at least one processor involves updating the covariances of magnetic field values of the magnetic map based at least in part on the second set for each platform.

### EXAMPLES

The examples set forth below in connection with the appended drawings is intended as a description of exemplary embodiments of the present disclosure and is not intended to represent the only exemplary embodiments in which the present disclosure can be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the specification. It will be apparent to those skilled in the art that the exemplary embodiments of the specification may be practiced without these specific details. In some instances, well known structures and devices are shown in block diagram form in order to avoid obscuring the novelty of the exemplary embodiments presented herein.

### 1.1. Initializing the Magnetic Map (145)

The magnetic map provides correlations between magnetic field values and positions. For example, a magnetic map can be considered as a database, every record of which can contain a 3D vector of magnetic field at a certain position. Besides the 3D vector of magnetic field, the record can contain its covariance as 3×3 covariance matrix as discussed below. In some embodiments, the magnetic map can also contain a history of magnetometer measurements transformed into the map frame with corresponding covariance of the magnetic measurements that may be supplemented with timestamps of the measurements and, possibly, other information. In some embodiments, besides magnetic field and covariance, the magnetic map may also contain other data, for example gradient of the magnetic field with relevant covariance for corresponding positions within the area.

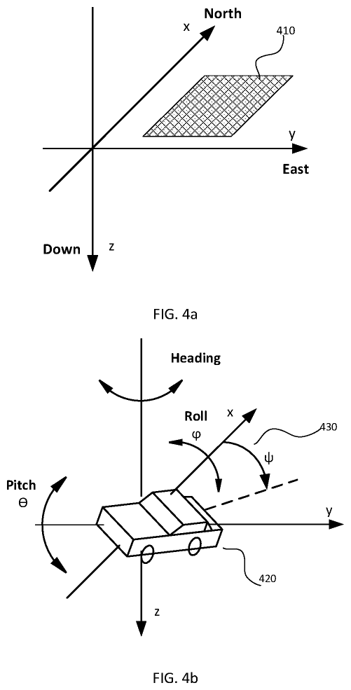

The positions in the magnetic map can be in any suitable coordinate frame, for example, a Cartesian frame like a global frame (ECEF) or a local frame (ENU or NED), or a geodetic (Lat/Lon) coordinate system. One example of a magnetic map in NED frame is depicted in FIG. 4a, wherein the positive X-axis points North, positive Y-axis points East, and positive Z-axis points Downward. An example of magnetic map is shown as a rectangle area 410 in the horizontal plane; however, the map can have a different shape. A grid that fills area 410 illustrates a possible structure of the magnetic map: each cell of the grid features a certain position (and contains the 3D vector of magnetic field possibly together with covariance and other information.) The magnetic map in FIG. 4a is shown as a layer at a specific height, but the map can also contain several layers at different heights as discussed further. For the purposes of clarity in this illustration, the magnetic map may be considered to be defined in the NED frame, which may also be referred to as a navigation frame, but in other embodiments, other suitable frames or systems may be employed and transformed as desired.

In one embodiment, the magnetic map can be initialized by values from one of global geomagnetic models, for example, World Magnetic Model (WMM) or International Geomagnetic Reference Field (IGRF) for the area. Diagonal elements of the covariance of the map can be set to big values that represents uncertainty of an initial value of the magnetic field. In other embodiments, the magnetic map can be initialized by results of previous survey or crowdsourcing mapping (if one of those is available) with the covariance that accounts for aging of the previously collected data. These variants of initialization of the magnetic map can be combined, i.e., a part of magnetic map can be initialized by available results of the previous survey or crowdsourcing, whereas the remaining part can be initialized by values from one of global geomagnetic models. Any other source of existing information for the magnetic map may also be employed as desired.

### 1.2. Obtaining Measurement Data for Each of a Plurality of Platforms Moving in the Area

As noted, the measurement data that is obtained may include magnetic field measurements, GNSS-based data or other sources of absolute navigational information, and motion sensor measurements. Each vehicle may have a magnetometer, a GNSS receiver, and a motion sensor for example. The GNSS receiver or other source of navigational information can provide one or a combination of the following data: PVT (Position, Velocity, and Time) solution and/or raw measurements, like pseudo-ranges and pseudo-Dopplers, together with other information like ephemeris for use with the techniques of this disclosure.

The motion sensor data may include information from inertial motion sensors such as accelerometers and gyroscopes, but may also include other sources of platform motion parameters such as odometry (e.g., wheel sensors), velocity sensors (e.g., a Doppler sensor), and/or a pressure sensor (e.g., a barometer). In many cases, platforms implemented as a vehicle may be equipped with some of the sensors listed above and there are standard ways of obtaining their information, for example, through CAN bus or OBD-2.

In general, the state of a rigid vehicle is described by its 3D Cartesian coordinates and 3 orientation angles (roll, pitch, and heading). Instead of Cartesian frames like ECEF and ENU/NED, any other coordinate frame can be used, e.g., the geodetic frame Lat/Lon. For clarity, this example is discussed in the context of 2D Cartesian coordinates and heading, which is measured clockwise from the direction to geographic or true North Pole. In this example, the motion sensor data provides at least the velocity νₜ, of the platform, measured by any combination of an odometry, a velocity sensor, and an IMU, and heading angular velocity, δψₜ measured by a gyroscope. For a pedestrian conveying a portable device, the motion sensor data may employ a type of pedestrian dead reckoning (PDR) and provide at least a step length lₜ and with heading angular velocity, δψₜ. As shown in FIG. 4b, orientation angles for the example of NED frame for an example of a car 420 may include the roll angle is the rotation around the X axis, φ, the pitch angle is the rotation around the Y axis, θ, and the heading (azimuth) angle is the rotation around the Z axis, wherein angle 430 is an example of heading ψ.

A 3D magnetometer measures magnetic field values in a body frame, which can also be termed a device frame. For this discussion, a magnetometer measurement may be defined as a vector with 3 components mₜ=(mₓₜ, m_{yt}, m_{zt}) wherein x, y, z represent the three components of magnetometer output, and t is an instant of the measurement. As the magnetometer measurements and the magnetic map values are in different frames, the magnetometer measurements may be transformed from the body (device) frame to a frame of magnetic map as above, such as the NED navigation frame in this context. As commonly known, transformation between frames can be described by transformation matrices.

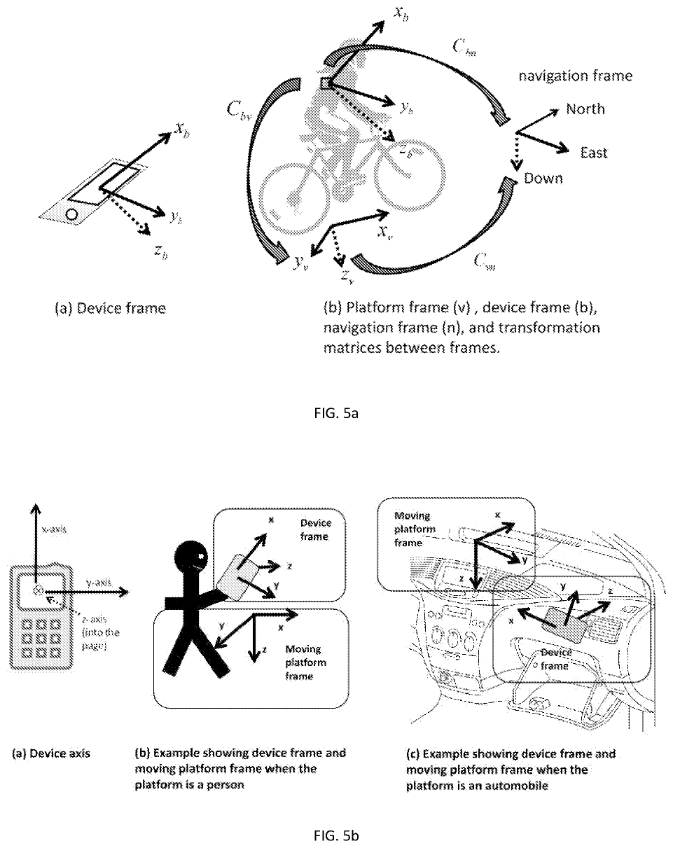

Correspondingly, FIG. 5a illustrates the relationship between frames for an example of a bicycle. Particularly, FIG. 5a shows the body (device) frame, in which magnetometer measurements are taken, platform frame, and NED (navigation) frame, which is a frame of the map of magnetic anomalies. The arrows illustrate transformation between frames. Index “b” refers to coordinate axes of the body frame and index “v” refers to the same of the platform frame like an example of a cyclist in FIG. 5a. Index “n” refers to the navigation frame, which is defined in FIG. 4a as the NED frame. The transformation matrices shown in FIG. 5a transform between the frames. Matrix C_{bv} transforms from the body frame to the platform frame, matrix Cᵥₙ transforms from the platform frame to the navigation frame, and matrix C_{bn} transforms from the body frame to the navigation frame. As another example, FIG. 5b shows a device frame and a platform frame for the cases of a pedestrian (a person) and a car. Although the navigation frame is not shown in FIG. 5b, it may be the same as in FIG. 5a. Correspondingly, transformation between the frames in FIG. 5b is described by the same matrixes as in FIG. 5a.

This data from the platforms is provided to the server or cloud for processing. One possibility is sending the data in real-time through available wireless and cellular channels of communication, such as noted above, while another possibility is recording the datasets on the platforms during their travel and later uploading the accumulated datasets for processing. After being obtained by the server, the datasets from the platforms are processed iteratively as indicated in FIGS. 1 and 2. In some embodiments, in addition to the motion sensor data discussed above, one or more of the platforms may also have configuration parameters, such as a height of the magnetometer installation above the ground and possibly about other parameters.

### 1.3 Determining a First Set of Platform Poses

This operation narrows the area of association of the magnetometer measurements with the magnetic map and thus may act to mitigate effect of ambiguity of magnetic field. The first set of platform poses is determined using the measurements from the platform, for example, absolute navigation information like GNSS and motion data. To achieve better accuracy, the data can be processed together, or fused, using one or another integration technique, for example, factor graph optimization (FGO), extended Kalman filter (EKF), or particle filter (PF). In this example, FGO is used with further discussion of possible use of the other techniques.

Let, for example, the state vector, describing the vehicle's pose, at least comprise the platform's 2D Cartesian coordinates x, y and heading ψ:

$${X}_{t} = {( {x}_{t} , {y}_{t} , {ψ}_{t} )}^{T} \qquad ( 1 )$$

In some embodiments, the state vector of Equation (1) can be extended to include more parameters, for example, altitude, velocity of the platform, etc. The time index may be defined as t=1, . . . , T with time increment Δt. The whole trajectory of the platform can be defined as a set of states Xₜ at time from 1 to T, i.e., X_{1:T}. The first set of platform's poses is an estimate \hat{X}_{1:T} of the trajectory X_{1:T}.

In FGO, the sensor measurements are considered as factors associated with specific states. Although FGO can accommodate different time stamps, for clarity of the description we assume that all the data have the same timestamps t=1, . . . , T. In some embodiments, if necessary, the data with different timestamps can be put to the same timestamps by interpolation.

The goal of factor graph optimization is to find an estimate \hat{X}_{1:T} by minimizing an objective function, which, for example, can be as follows:

$${X}_{t} = {( {x}_{t} , {y}_{t} , {ψ}_{t} , {δ}_{t} )}^{T} \qquad ( 5 )$$

In Equation (2) a common definition of Mahalanobis distance is used:

$${‖ a ‖}_{Q}^{2} = {a}^{T} {Q}^{- 1} a \qquad ( 3 )$$

The first addend in the sum of equation (2) is a motion sensor factor, representing platform motion. Taking for example a simplified platform's motion model, function q can be as follows:

$$q ( {X}_{t - 1} , {u}_{t} ) = {X}_{t - 1} + [ \begin{matrix}{v}_{t} \cdot Δ t \cdot cos ( {ψ}_{t - 1} ) \\ {v}_{t} \cdot Δ t \cdot sin ( {ψ}_{t - 1} ) \\ {δψ}_{t} \cdot Δ t\end{matrix} ] \qquad ( 4 a )$$

where uₜ=(vₜ, δψₜ)^{T}, vₜ is platform's velocity measured, for example, by a wheel sensor, δψₜ is heading angular velocity, measured by a gyroscope and Λ_{qt} is covariance associated with motion sensor measurements.

For the case of a pedestrian, the simplified motion model may be expressed as follows:

$$q ( {X}_{t - 1} , {u}_{t} ) = {X}_{t - 1} + [ \begin{matrix}{l}_{t} \cdot cos ( {ψ}_{t - 1} ) \\ {l}_{t} \cdot sin ( {ψ}_{t - 1} ) \\ {δψ}_{t} \cdot Δ t\end{matrix} ] \qquad ( 4 b )$$

where uₜ=(lₜ, δψₜ)^{T}, lₜ is pedestrian's step length measured by PDR, and δψₜ is heading angular velocity, measured by a gyroscope. The second addend in Equation (2) is a GNSS factor. If the GNSS receiver provides a PVT solution with Yₜ as a GNSS-based position, function g(Xₜ) is an expected position and Λ_{gt} is a covariance of the GNSS position measurement. If, in some embodiments, the GNSS receiver can provide raw measurements, for example, pseudo-ranges, they can also be accommodated for obtaining the first set of poses. In this case, commonly known as tightly coupled integration or simply tight integration, the state vector of Equation (1) can be extended by including clock shift δₜ of the GNSS receiver (assuming use of one constellation, e.g., GPS):

$${X}_{t} = {( {x}_{t} , {y}_{t} , {ψ}_{t} , {δ}_{t} )}^{T} \qquad ( 5 )$$

The objective function of Equation (2) can be then modified to include a pseudo-range factor:

$${\hat{X}}_{1 : T} = arg {min}_{{X}_{1 : T}} \{ {\sum }_{t} {‖ q ( {X}_{t - 1} , {u}_{t} ) - {X}_{t} ‖}_{{Λ}_{qt}}^{2} + {\sum }_{t , j} {‖ {p}_{j} ( {X}_{t} ) - {ρ}_{tj} ‖}_{{Λ}_{ptj}}^{2} \} \qquad ( 6 )$$

where: ρₜⱼ is a pseudo-range to j-th satellite measured by the GNSS receiver, j=1, . . . , Nₜ, Λₚₜⱼ is a covariance related to pseudo-range measurement ρₜⱼ, and Nₜ is a number of observable satellites.

An expected j-th pseudo-range is given by the measurement function:

$${p}_{j} ( {X}_{t} ) = ‖ {X}_{tj}^{Sat} - {X}_{t} ‖ + {c}_{L} \cdot {δ}_{t} + δ {r}_{tj} \qquad ( 7 )$$

where: Xₜⱼ^{Sat} is a position of j-th satellite calculated by use of the satellite's ephemeris, c_{L} is speed of light, and δrₜⱼ is a term that includes such effects as an ionospheric propagation error, a tropospheric propagation error, and the Earth rotation. Different methods of correction of such errors are known in the art and therefore are not discussed here.

A benefit of using raw GNSS measurements is that the pseudo-ranges contaminated by strong multipath and NLOS situations, which are typical for dense urban environment, can be detected and excluded from equation (6) that can help to achieve better accuracy of determination of the first set of platform's poses. Different methods can be used for detection of the contaminated pseudo-ranges, for example, GNSS shadow matching with 3D city maps, the M-estimator, and other approaches known in the art.

The approach of using raw GNSS measurements like pseudo-ranges described above for one constellation, e.g., GPS, can be extended for several constellations like GALILEO, GLONASS, and BeiDou by adding clock shifts for additional constellation in Equations (5)-(7). In some embodiments, the raw GNSS measurements can additionally include pseudo-Dopplers, which can be also utilized in the objective function as in Equation (6).

To determine the first set of platform's poses \hat{X}_{1:T} by minimizing the objective function of Equation (2) or (6), a linearized iterative procedure can be applied, for example, Gauss-Newton or Levenberg-Marquardt algorithms. After the iterations completed, the covariance Σ_{X} of the first set of poses can be determined as well.

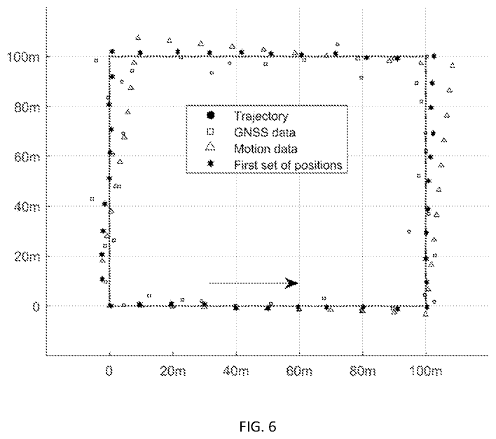

Therefore, FIG. 6 illustrates an example of determination of the first step of positions, which is based on simulation of platform's motion and data from a GNSS receiver and from a motion sensor. Small, filled dots in FIG. 6 show a square-shaped platform's true trajectory that starts at (0,0), moves counterclockwise as the horizontal arrow indicates, and finishes in the same location. Squares show GNSS-based positions whereas triangles show positions based on the motion data. Filled hexagrams show the first set of platform positions obtained by minimization of objective function of Equation (2) as described above. It can be noticed that due to fusion of GNSS-based and motion data the determined first set of positions is closer to the platform's true trajectory than other sources of data.

In some embodiments, other sources of data can be incorporated into the objective functions of Equations (2) or (6) as additional factors. For example, it can be wireless data either in the form of platform's positions or ranges from the platform to Wi-Fi access points measured for example by such method as Wi-Fi RTT. Further, one or more platforms may be equipped with such means as camera, lidar, or/and radar. Their measurements can be also used for determination of the first set of poses by incorporating into the objective functions of Equations (2) or (6) as additional factors. In another example, magnetic heading determined outside the magnetic anomalies can be used as noted below. One more example is using platform's velocity vector from GNSS PVT solution. These additional sources of data, if available, can help to determine the first set of poses more accurately.

### 1.4 Obtaining a Partial Magnetic Map for the First Set of Platform Poses (152)

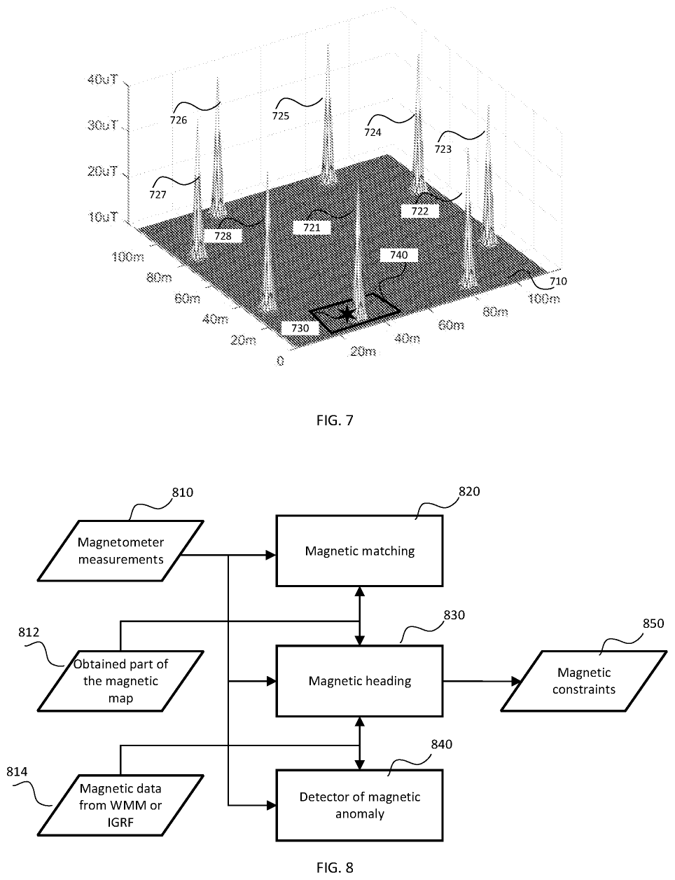

FIG. 7 illustrates obtaining a part of the magnetic map for the first set of platform poses and shows an illustrative example of one component of the simulated magnetic map as a 3D picture wherein horizontal axes defines positions in meters and the vertical axis defines magnetic field in micro-Tesla (uT) for each position. The magnetic map in this example comprises area 710 with constant level of Earth magnetic field and 8 equal magnetic anomalies 721-728. Equality of these magnetic anomalies illustrate ambiguity of magnetic field, that means that the same values of magnetic field can be in different locations. Ambiguity of magnetic field makes magnetic data association more difficult, and what is proposed helps to solve this problem.

Hexagram (6-point star) 730 shows one of positions \hat{X}ₜ at time t from the determined first set of platform poses \hat{X}_{1:T}. Rectangle 740 encompasses the part of the magnetic map around position \hat{X}ₜ from the first set of platform poses. Only values of the magnetic map within the rectangle will be used for association of the magnetometer measurement with the magnetic map. Due to this, only magnetic anomaly 721, which is closest to the position 730, impacts on data association, and impact of other magnetic anomalies 722-728 shown in the picture is eliminated. The parts of the magnetic map for other positions from the first set of positions are obtained in the same way as was demonstrated for the position \hat{X}ₜ. Covariance of the magnetic map that relates to the obtaining part of the magnetic map may be extracted as well.

A rectangular shape 740, which encompasses the part of the magnetic map for the position 730, was drawn as an example, and other shapes can be used, for example, an ellipse. Dimensions of the area within rectangular or elliptic shapes can be chosen to cover uncertainty of the first set of positions, as defined by the covariance Σ_{X} of the first set of poses. For example, in the case of elliptic shape, semiaxes of the ellipse can be proportional to the square root of diagonal elements of the covariance. With the often-used coefficient of proportionality 3, the part of the magnetic map for a specific position from the first set of positions will be determined with a probability of more than 0.95.

For context of this example, the obtained part of the magnetic map centered at \hat{X}ₜ∈\hat{X}_{1:T} and sized by Σ_{Xt} may be defined as

$${μ}_{t} = M ( {\hat{X}}_{t} , {Σ}_{Xt} ) \qquad ( 8 )$$

Further, the covariance of the obtained part of the magnetic map may be defined as

$${Ω}_{t} = {Σ}_{M} ( {\hat{X}}_{t} , {Σ}_{Xt} ) . \qquad ( 9 )$$

### 1.5 Determining Magnetic Constraints on the Platform's Poses (153)

In a crowdsourcing scenario, many platforms move across a city by overlapping trajectories. As shown in FIG. 1, the datasets obtained from platforms' equipment (a magnetometer, GNSS receiver, and a motion sensor) are processed one by one to incrementally update the magnetic map. When processing the next dataset, a previously created magnetic map may be used for more accurate determination of the platform's position for the next dataset that contributes to a more accurate update of the magnetic map on the next step. For this purpose, magnetic constraints for the platform's pose may be determined using the magnetometer measurements and the obtained part of the magnetic map.

FIG. 8 shows one exemplary embodiment of a module 153 for determining magnetic constraints. The input data for determination of the magnetic constraints may, for example, include magnetometer measurements mₜ (810) with related platform's poses Xₜ from the first set of positions and covariances Σₜ and the obtained parts of the magnetic map μₜ (812) with covariance Ωₜ. The magnetic data 814 from the WMM of IGRF for the platform's positions can be also used. Output 850 of the module is the magnetic constraints to be used on the next step of the iterative process. The module may include such submodules like magnetic matching 820, magnetic heading determination 830, and detector of magnetic anomalies 840. Examples of these specific magnetic constraints are given below.

A. Estimating Platform Location with Magnetometer Measurements Matching

By comparing magnetometer measurements with magnetic field values in the obtained part of the magnetic map, a probable location of the platform may be determined by the best match between the measurement and the value of the magnetic field for a specific location. Several variants of matching are possible, for example, using magnitude of magnetic field, using separate horizontal and vertical components of magnetic field, or using 3D vector of magnetic field. Submodule 820 of FIG. 8 is configured for this purpose.

For example, in one embodiment, comparing magnitudes of the magnetometer measurement 810 ∥mₜ∥=\sqrt{mₓₜ²+m_{yt}²++m_{zt}²} with magnitudes of all values of the obtained part of the magnetic map 812 ∥μₜ(Xᵢ)∥=\sqrt{μ(Xᵢ)ₓₜ²+μ(Xᵢ)_{yt}²+μ(Xᵢ)_{zt}²}, we can determine a platform location by maximizing a probability of the match:

$${\hat{V}}_{t} = {agr max}_{{X}_{i} ∈ \{ {μ}_{t} \}} \{ \frac{1}{\sqrt{2 π ( {σ}_{‖ {m}_{t} ‖}^{2} + {σ}_{‖ {μ}_{t} ( {X}_{i} ) ‖}^{2} )}} exp ( - \frac{{( ‖ {m}_{t} ‖ - ‖ {μ}_{t} ( {X}_{i} ) ‖ )}^{2}}{2 ( {σ}_{‖ {m}_{t} ‖}^{2} + {σ}_{‖ {μ}_{t} ( {X}_{i} ) ‖}^{2} )} ) \} \qquad ( 10 )$$

where: σ_{∥m}_{ₜ}_{∥}² is variance of the magnitude of the magnetometer measurement and σ_{∥μ}_{ₜ}_{(X}_{ₜ}_{)∥}² is variance of the magnitude of the magnetic map for position Xᵢ.

In another embodiment, the platform's location may be more accurately determined by computing weights for several neighbor locations around the location \hat{V}ₜ:

$${w}_{i} = \frac{1}{\sqrt{2 π ( {σ}_{‖ {m}_{t} ‖}^{2} + {σ}_{‖ {μ}_{t} ( {X}_{i} ) ‖}^{2} )}} exp ( - \frac{{( ‖ {m}_{t} ‖ - ‖ {μ}_{t} ( {X}_{i} ) ‖ )}^{2}}{2 ( {σ}_{‖ {m}_{t} ‖}^{2} + {σ}_{‖ {μ}_{t} ( {X}_{i} ) ‖}^{2} )} ) \qquad ( 11 )$$

The weights represent the likelihoods of the platform's location Xᵢ given the magnetometer measurement mₜ, where all positions Xᵢ are inside the obtained part of the magnetic map μₜ. The weights may be normalized as follows:

$${w}_{i}^{′} = {w}_{i} / \sum {w}_{i} , \qquad ( 12 )$$

And weighted average platform's location then may be determined as follows:

$${\hat{V}}_{t} = \sum {w}_{i}^{′} {X}_{i} \qquad ( 13 )$$

Further, the covariance of the platform's location may be estimated:

$${C}_{{\hat{V}}_{t}} = \sum {w}_{i}^{′} ( {X}_{i} - {\hat{V}}_{t} ) {( {X}_{i} - {\hat{V}}_{t} )}^{T} \qquad ( 14 )$$

As will be appreciated, Equations (10) and (11) may be modified using the same approach for other variants of matching, for example, using separate horizontal component ∥mₕₜ∥=mₓₜ²+m_{yt}², and vertical component m_{zt} of magnetic field rather than using the magnitude of magnetic field.

Particularly, horizontal and vertical components can be estimated using roll and pitch angles, φ and θ respectively (see FIG. 4b for the definition of the angles):

$${m}_{ht} = \sqrt{{( {m}_{xt} cos {θ}_{t} + {m}_{zt} sin {θ}_{t} )}^{2} + {( {m}_{yt} cos {φ}_{t} + {m}_{xt} sin {φ}_{t} sin {θ}_{t} - {m}_{zt} sin {φ}_{t} cos {θ}_{t} )}^{2}} \\ {m}_{vt} = {m}_{yt} sin {φ}_{t} - {m}_{xt} cos {φ}_{t} sin {θ}_{t} + {m}_{zt} cos {φ}_{t} cos {θ}_{t} \qquad ( 15 )$$

As commonly known, roll and pitch angels, φ and θ respectively, can be determined through a gravity vector measured by a 3D accelerometer so that all components of Equation (15) are defined.

### B. Several Consecutive Measurements

The use of matching several consecutive magnetometer measurements 810 with the obtained part of the magnetic map 812 can further improve the magnetic data association for the situations of bigger dimensions of area 740 which may be in case of less accurate determination of some of locations of the first set of poses. The same variants of magnetic data noted above may be used, for example, magnitude of magnetic field, or separate horizontal and vertical components of magnetic field, or 3D vector of magnetic field.

For example, Let d_{t-k+1:t} define a series of k last magnetic measurements taken in succession from time t−k+1 to time t, wherein dₜ can be a magnitude of magnetometer measurements ∥mₜ∥, or combination of horizontal ∥mₕₜ∥ and vertical m_{zt} components of the measurements, or a 3D vector of magnetometer measurements mₜ. To determine the magnetic constraint for platform's position using a series of magnetic measurements, these may be compared with candidate series of values of the obtained part of the magnetic map, which is defined as s_{t-k+1:t}^{j}, wherein sₜ can be a magnitude of magnetic map ∥μₜ∥, or combination of horizontal ∥μₕₜ∥ and vertical μ_{zt} components of the map, or a 3D value of magnetic map μₜ, and j is a candidate series number.

The best match between the consecutive magnetic measurements and the obtained part of the magnetic map may be found by minimizing a difference between a series of magnetic measurements and candidate series of magnetic map according to the following:

$$\hat{j} = {arg min}_{j} \{ F ( {d}_{t - k + 1 : t} - {s}_{t - k + 1 : t}^{j} ) \} \qquad ( 16 )$$

where F is a metric for comparison of two series, for example, Euclidean distance between two series of magnetic data.

As every value of magnetic map is correlated with a specific location, the constraint on platform's position \hat{V}ₜ may be determined as a location of the last element in the best matching sequence sₜ^{î}. One of ordinary skill in the art will appreciate that different methods can be used for minimization of Equation (16), for example, Dynamic Time Warping (DTW.)

### C. Magnetic Heading Using Models

Submodule 830 helps to determine magnetic heading. Magnetometer measurements mₜ taken outside the magnetic anomalies can be used for determination of heading using the following equation:

$${\hat{ψ}}_{mt} = {tan}^{- 1} \frac{{m}_{yt}}{{m}_{xt}} + d , \qquad ( 17 )$$

where d is the magnetic declination angle, which is an angle in horizontal plane between magnetic north and true north. The magnetic declination angle for a given position can be determined using data 814 from magnetic models, e.g., from earlier mentioned WMM or IGRF.

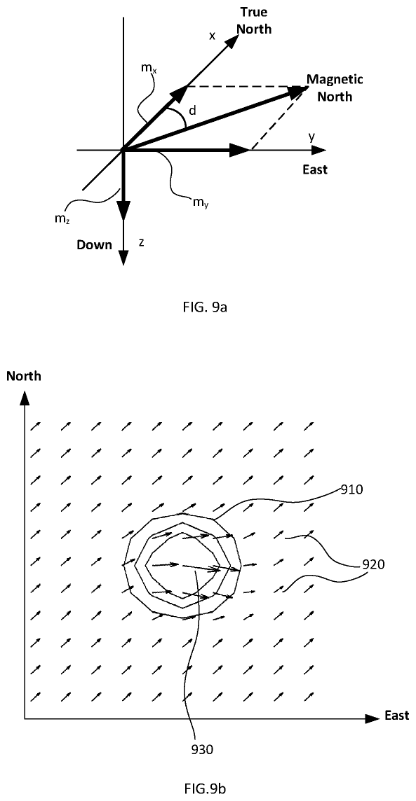

Thus, FIG. 9a illustrates the 3D vector of magnetic field with components mₓ, m_{y}, and m_{z} shown in NED frame (see FIG. 4a) wherein d is the magnetic declination angle. FIG. 9b illustrates impact of magnetic anomalies on magnetic heading. Contour lines 910 show levels of a magnetic anomaly like one of magnetic anomalies 721-728 of FIG. 7. Arrows 920 outside the contours, i.e., outside the magnetic anomaly, illustrate original magnetic field of Earth. Arrows 930 inside the contours shows magnetic field disturbed by the anomaly. It can be notices that the direction of magnetic field 930 inside the magnetic anomaly is different from the field 920 outside.

A module for detecting magnetic anomaly 830 can help to determine magnetic heading outside the magnetic anomaly according to Equation (17). Several methods are known for detection of magnetic anomalies, for example, by comparison of magnitude ∥mₜ∥ of magnetometer measurements with magnitude of Earth's magnetic field given by WMM or IGRF for the platform's position. If difference of the two magnitudes exceeds a predetermined threshold, it is decided that the measurement was taken inside the anomaly and should not be used as for magnetic heading determination. Another method that can be is based on comparison of a horizontal magnitude and a vertical component of magnetometer measurements with the respective values of Earth's magnetic field given by the magnetic models.

If a magnetic anomaly has been detected, the magnetic heading of Equation (17) should not be used. Standard deviation σ_{\hat{ψ}}_{ₘₜ} the heading estimate may be used to indicate whether to use the estimate or to diminish its effect. For example, the standard deviation can be defined as follows:

$${σ}_{{\hat{ψ}}_{mt}} = \{ \begin{matrix}{σ}_{0} , if mag anomaly has not been detected \\ {σ}_{b} , otherwise\end{matrix} , \qquad ( 18 )$$

where: σ₀ is accuracy of magnetic heading determination, which is usually specified by a manufacturer of the magnetometer and σ_{b}»σ₀ is some sufficiently large value that de-weights impact the magnetic heading estimate if a magnetic anomaly has been detected.

### D. Magnetic Heading Using the Obtained Partial Magnetic Map.

The previous method of magnetic heading determination relies on a magnetic model and therefore it can be used even if the magnetic map has not been created yet. However, as discussed in above, it cannot be used in the locations with magnetic anomalies. If the magnetic map has been at least partly determined using preceding datasets from platforms, magnetic heading may be estimated for the current dataset based on magnetometer measurements 810 and the obtained part of the magnetic map 812 including locations with magnetic anomalies 930.

A simplified equation for determination of magnetic heading for this method can be as follows:

$${\hat{ψ}}_{mt} = {tan}^{- 1} \frac{{μ ( {X}_{t} )}_{x} {m}_{yt} - {μ ( {X}_{t} )}_{y} {m}_{xt}}{{μ ( {X}_{t} )}_{x} {m}_{xt} - {μ ( {X}_{t} )}_{y} {m}_{yt}} \qquad ( 19 )$$

where components of the magnetic map for position Xₜ and components of magnetometer measurements are the same as defined in above.

Both methods of determining magnetic heading may be used in combination for different parts of the magnetic map respectively outside (920) and inside (930) the magnetic anomalies.

### E. Combination of Magnetic Constraints

Magnetic constraints 850 on platform's poses discussed above, including constraints on position (sections A. and B.) and heading (sections C. and D.), can be combined in one vector of constraints on platform's poses, for example, as follows:

$$h ( {m}_{t} ) = {( {\hat{V}}_{t} , {\hat{ψ}}_{mt} )}^{T} \qquad ( 20 )$$

The covariance of the magnetic constraints may be determined, for example, as follows:

$${Λ}_{ht} = [ \begin{matrix}{C}_{{\hat{V}}_{t}} & 0 \\ 0 & {σ}_{{\hat{ψ}}_{mt}}^{2}\end{matrix} ] \qquad ( 21 )$$

The determined magnetic constraints and their covariance may then be used in the next step of determining the second set of platform poses.

### 1.6 Determining a Second Set of the Platform's Poses (154)

The second set of poses \hat{X}_{1:T} may be defined as with the first set of poses as an estimate of the platform's trajectory X_{1:T}={(xₜ,yₜ,ψₜ)^{T}}_{t=1, . . . ,T} with additional use of magnetic constraints h(mₜ) according to Equation (20) for more accurate estimation of the set of poses.

The second set of platform's poses can be determined by a suitable state estimation technique like, for example, the FGO, that was used for determination of the first set of poses, with use of an additional factor of magnetic constraints determined on the previous step. The modified objective function of Equation (2) combining motion data, GNSS position, and magnetic constraints can, for example, be represented as:

$${\hat{X}}_{1 : T} = arg {min}_{{X}_{1 : T}} \text{} \{ {\sum }_{t} {‖ q ( {X}_{t - 1} , {u}_{t} ) - {X}_{t} ‖}_{{Λ}_{qt}}^{2} + {\sum }_{t} {‖ g ( {X}_{t} ) - {Y}_{t} ‖}_{{Λ}_{gt}}^{2} + {\sum }_{t} {‖ h ( {m}_{t} ) - {X}_{t} ‖}_{{Λ}_{ht}}^{2} \} \qquad ( 22 )$$

Likewise, the modified objective function of Equation (6) for tight integration case combining motion data, GNSS raw data, and magnetic constraints may be represented as:

$${\hat{X}}_{1 : T} = arg {min}_{{X}_{1 : T}} \text{} \{ {\sum }_{t} {‖ q ( {X}_{t - 1} , {u}_{t} ) - {X}_{t} ‖}_{{Λ}_{qt}}^{2} + {\sum }_{t , j} {‖ {p}_{j} ( {X}_{t} ) - {ρ}_{tj} ‖}_{{Λ}_{ptj}}^{2} + {\sum }_{t} {‖ h ( {m}_{t} ) - {X}_{t} ‖}_{{Λ}_{ht}}^{2} \} \qquad ( 23 )$$

Motion and GNSS factors in Equations (22) and (23) are the same as in objective functions for the first set of poses of Equations (2) and (6) respectively. Due to the magnetic constraints according to Equation (20) being linearizable, the optimization can be performed in the same way as was described in section 1.3, and the second set of poses \hat{X}_{1:T} can be determined by an iterative algorithm, for example, Gauss-Newton or Levenberg-Marquardt. A relevant covariance Σ_{X} of the second set of poses may be determined as well.

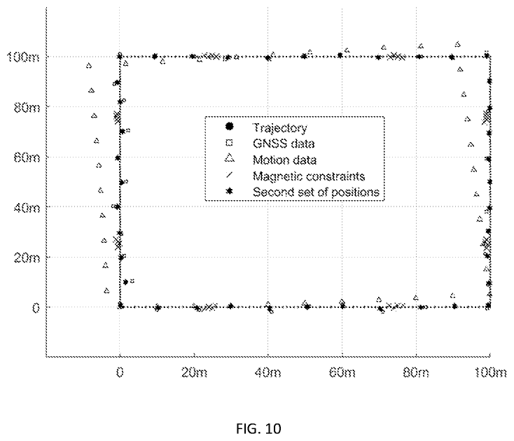

Correspondingly, FIG. 10 illustrates an example of determination of the second set of positions. As in FIG. 6 for the first set of positions, small, filled dots in FIG. 10 show a square-shaped platform's true trajectory that starts at (0,0), moves counterclockwise, and finishes in the same location. Squares show GNSS-based positions whereas triangles show positions based on the motion data. Crosses show magnetic constraints on platform's positions. The magnetic constraints are shown only for positions where diagonal elements of covariance of the magnetic constraints are small because the constraints in other positions provide weaker impact on optimization of objective function of Equation (22) or (23). It can be noticed that valuable magnetic constrains coincide with locations of magnetic anomalies 721-728 shown in FIG. 7. Filled hexagrams show the second set of platform positions obtained by minimization of objective function of Equation (22) as described above. Due to use of magnetic constraints, the determined second set of positions is closer to the platform's true trajectory than the first set of position shown in FIG. 6, allowing more accurate updating of the magnetic map.

As with determination of the first set of positions, other sources of data can be included to objective functions of Equation (22) or (23) as additional factors for determination of the second set of positions. For example, wireless data either in a form of platform's positions or ranges from the platform to Wi-Fi access points measured for example by such method as Wi-Fi RTT. Further, one or more platforms may be equipped with such means as camera, lidar, or/and radar. Their measurements can also be used for determination of the second set of positions by incorporation into the objective functions of Equation (22) or (23) as additional factors. One more example is using platform's velocity vector from a GNSS PVT solution. These additional sources of data, if available, can help to determine the second set of positions more accurately.

### 1.7 Updating the Magnetic Map (155)

Having determined the second set of platform's poses, which is more accurate due to use of additional magnetic constraints, the magnetic map 140 can be updated using the magnetometer measurements. The covariance of the magnetic map may be updated as well. As was defined in Equation (1), the platform's pose can comprise the platform's 2D Cartesian coordinates xₜ, yₜ, and heading ψₜ.

The second set of poses \hat{X}_{1:T}={(\hat{x}ₜ,ŷₜ,\hat{ψ}ₜ)^{T}}_{t=1, . . . ,T} has been determined for n-th dataset with relevant covariance of poses Σ_{X} tied with 3D magnetometer measurements mₜ in body (device) frame with covariance Σₘₜ. Transforming the magnetometer measurements from the body frame to the frame of magnetic map (navigation frame) may be achieved as follows:

$${m}_{t}^{′} = {C}_{bnt} {m}_{t} , \qquad ( 24 )$$

where C_{bnt} is a transformation matrix from a body frame of the magnetometer to the navigation frame or the frame of the magnetic map (as per section 1.2 and FIG. 5a for the definition of transformation matrix C_{bn} while the additional index t indicates that the orientation angles can be varying with time).

The transformation matrix can be represented as follows (as per the definition of orientation angles in 1.2 and FIG. 4b:

$${C}_{bnt} = [ \begin{matrix}cos {θ}_{t} cos {ψ}_{t} & \begin{matrix}- cos {φ}_{t} sin {ψ}_{t} + \\ sin {φ}_{t} sin {θ}_{t} cos {ψ}_{t}\end{matrix} & \begin{matrix}sin {φ}_{t} sin {ψ}_{t} + \\ cos {φ}_{t} sin {θ}_{t} cos {ψ}_{t}\end{matrix} \\ cos {θ}_{t} sin {ψ}_{t} & \begin{matrix}cos {φ}_{t} cos {ψ}_{t} + \\ sin {φ}_{t} sin {θ}_{t} sin {ψ}_{t}\end{matrix} & \begin{matrix}- sin {φ}_{t} cos {ψ}_{t} + \\ cos {φ}_{t} sin {θ}_{t} sin {ψ}_{t}\end{matrix} \\ - sin {θ}_{t} & sin {φ}_{t} cos {θ}_{t} & cos {φ}_{t} cos {θ}_{t}\end{matrix} ] \qquad ( 25 )$$

As noted above, roll and pitch angels, φₜ and θₜ respectively, can be determined through a gravity vector measured by a 3D accelerometer, whereas heading it is a component of the determined second set of the platform's poses as explained in previous paragraphs so that the transformation matrix is fully defined.

Covariance of magnetometer measurements includes several components is described in detail in commonly-owned U.S. Pat. No. 11,035,915, which is hereby incorporated by reference in its entirety. A simplified variant for the purposes of this disclosure may be represented as:

$${Φ}_{mt} = {C}_{bnt} ( {P}_{t} + Q ) {C}_{bnt}^{T} \qquad ( 26 )$$

where Q is covariance of magnetometer noise. Assuming that the three components of magnetometer noise are independent and have the same standard deviation σₘ, the covariance can be expressed as follows:

Q=σₘ²I₃,

where σₘ is standard deviation of magnetometer noise, which may usually be determined from the manufacture's specification for the magnetometer, and I₃ is 3×3 identity matrix.

Component Pₜ of Equation (26) is caused by erroneous device orientation angles. With simplification for small values of orientation angle variances, matrix Pₜ may be expressed according to Equation (27):

$${P}_{t} [ \begin{matrix}{σ}_{ψ t}^{2} {m}_{yt}^{2} + {σ}_{θ t}^{2} {m}_{zt}^{2} & - {σ}_{ψ t}^{2} {m}_{xt} {m}_{yt} & - {σ}_{θ t}^{2} {m}_{xt} {m}_{zt} \\ - {σ}_{ψ t}^{2} {m}_{xt} {m}_{yt} & {σ}_{ψ t}^{2} {m}_{xt}^{2} + {σ}_{φ t}^{2} {m}_{zt}^{2} & - {σ}_{φ t}^{2} {m}_{yt} {m}_{zt} \\ - {σ}_{θ t}^{2} {m}_{xt} {m}_{zt} & - {σ}_{φ t}^{2} {m}_{yt} {m}_{zt} & {σ}_{φ t}^{2} {m}_{yt}^{2} + {σ}_{θ t}^{2} {m}_{xt}^{2}\end{matrix} ] , \qquad ( 27 )$$

where σ_{φt}², σ_{θt}², σ_{ψt}² are variances of estimate of platform's roll, pitch, and heading angles respectively.

It can be noticed that conversion of magnetometer measurements from a device (body) frame to the navigation frame of magnetic map creates additional errors (although not magnetometer noise and biases errors) caused by errors of orientation angles.

In one embodiment, the magnetic map 140 and its covariance are recursively updated by adding a portion of the current magnetometer measurements mₜ′ to the preceding value of magnetic map μₙ₋₁, created by processing n−1 datasets. The weight of adding magnetometer measurement depends on relation between covariances of the magnetic map and the measurements. For example, if the magnetometer measurements are more accurate, which means that their covariance Φₘₜ is smaller than covariance of magnetic map Ω_{μ}, then they are added in larger degree. These conditions can be written as follows:

$${μ}_{n} ( {x}_{t} , {y}_{t} ) = {Ω}_{μ n} ( {x}_{t} , {y}_{t} ) [ {Ω}_{μ , n - 1}^{- 1} ( {x}_{t} , {y}_{t} ) {μ}_{n - 1} ( {x}_{t} , {y}_{t} ) + {Φ}_{mt}^{- 1} {m}_{t}^{′} ] \qquad ( 28 )$$

where: μₙ₋₁ (xₜ, yₜ) is a preceding value of the magnetic map for position (xₜ, yₜ), Ω_{μ,n-1}(xₜ, yₜ) is a covariance of the preceding value of the magnetic map for the same position, μₙ(xₜ,yₜ) is the updated value of the magnetic map for position (xₜ,yₜ) after processing n-th dataset and Ω_{μn} (xₜ, yₜ) is recursively updated covariance of the magnetic map for position (xₜ, yₜ) after processing n-th dataset that is computed as follows:

$${Ω}_{μ n} ( {x}_{t} , {y}_{t} ) = {( {Ω}_{μ , n - 1}^{- 1} ( {x}_{t} , {y}_{t} ) + {Φ}_{mt}^{- 1} )}^{- 1} \qquad ( 29 )$$

In another embodiment, as was noted in section 1.1, an additional set of magnetometer measurements m_{t,i}′ may be collected for n−1 preceding datasets with related covariance Φ_{mt,i} for each dataset, wherein i is a number of the dataset. The preceding measurements may be processed together with the current measurements so that n magnetometer measurements are transformed from a body frame to a navigation frame: m_{i,t}′=C_{bnt}m_{i,t}, i=1, . . . , n. In this embodiment, a robust procedure of estimating the magnetic map may be used, such as described in our U.S. Pat. No. 11,035,915, incorporated above. Any given magnetic field measurement for a certain position may be potentially corrupted by contaminating measurements. For example, a positioning error may cause magnetometer measurements to be incorrectly associated with a location even though they would be accurate for the correct location. The robust procedure allows mitigation of this effect and a more accurate estimation of the magnetic field values.

In a further example, the parameters of the magnetic map may be estimated separately for the X, Y, and Z components of the magnetic vector by using M-estimator, however, other known robust estimation techniques can also be used. As such, the discussion below relates to the determination of a location and a scale for the X component of a magnetic field, and it should be recognized that the Y and Z components may be found using similar approaches. For every position within the magnetic map, the value of magnetic field μ_{x,n} is estimated from the equation:

$${\sum }_{i = 1}^{n} \frac{1}{{σ}_{x , i}} ρ ( \frac{{m}_{x , i}^{′} - {μ}_{x , n}}{{σ}_{x , i}} ) = 0 , \qquad ( 30 )$$

where: μₙ is the estimating value of X component of magnetic field at a specific location within the magnetic map, m_{x,i}′ (i=1, . . . , n) is magnetometer measurement of X component of magnetic field in the frame of the magnetic map for the same location for n datasets, σ_{x,i} is standard deviation of the X component of magnetic field measurements m_{x,i}′ for that position, which can be taken from a diagonal element of covariance Φm_{t,i} and ρ is a non-linear function.

As will be appreciated, this equation accommodates conditions in which the magnetic field measurements m_{x,i}′, i=1, . . . , n have different standard deviations σ_{x,i}, i=1, . . . , n. Using uncertainties σ_{x,i} of every measurement and the nonlinear function p allows all measurements to correctly take this into account and mitigate the effect from contaminating measurements. Depending on the embodiment, examples of suitable nonlinear functions p that may be employed to provide estimation of a location parameter in presence of erroneous measurements include Huber's, “biweight” Tukey's, Humpel's, Andrews' and other similar functions. Other components of magnetic field (μ_{y,n} and μ_{z,n}) are determined from the same equation using corresponding components of the magnetometer measurements (m_{y,i}′ and m_{z,i}′) and standard deviations (σ_{y,i} and σ_{z,i}). Notably, the iterative procedure described in U.S. Pat. No. 11,035,915 allows determination of magnetic field μₙ for the specific location and determination of components of the covariance of magnetic map.

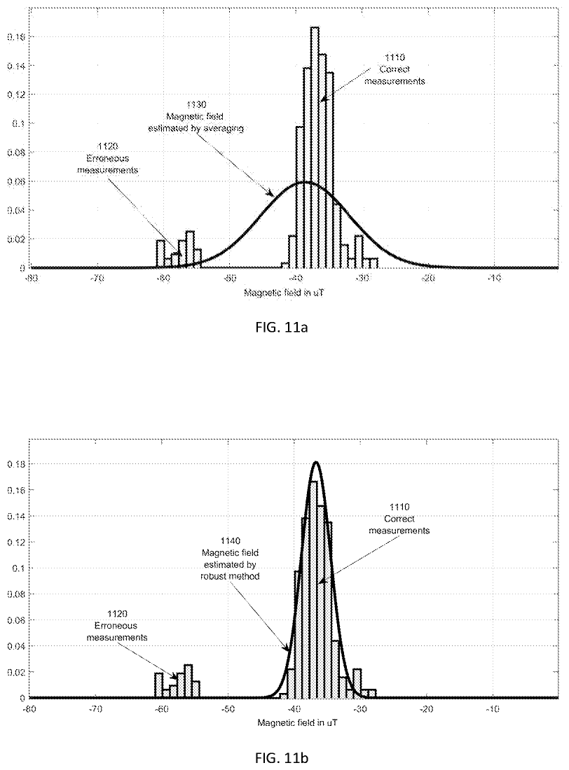

Exemplary results of the above techniques are depicted in FIGS. 11-16. Specifically, FIG. 11 illustrates the robust procedure for mitigating contaminating measurements, with FIG. 11a showing a histogram of one component of magnetometer measurements for a specific location, which consists of correct measurements 1110 of Earth magnetic field and erroneous measurements 1120 cause by different reasons, for example, by errors of portable device's position and attitude determination. The curve of normal distribution 1130 in FIG. 11a shows that magnetic field was estimated inaccurately by use of traditional averaging of all magnetometer measurements. As can be seen, the magnetic field was estimated with bias (shifted to left from correct value) and the standard deviation of magnetic field was significantly bigger than its true value. Conversely, FIG. 11b shows the same histogram of one component of magnetometer measurements for a specific location. The curve of normal distribution 1140 in FIG. 11b shows that magnetic field was estimated accurately by use of robust procedure of Equation (30). Erroneous measurements were effectively neglected, and both magnetic field and its standard deviation are correct that leads to more accurate update of the magnetic map 140.

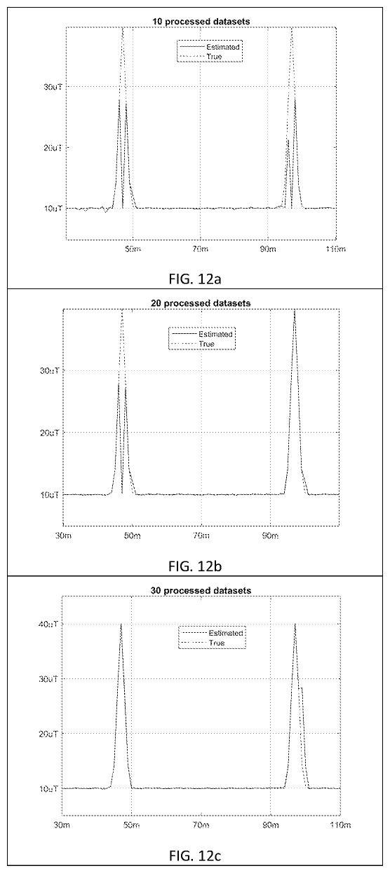

Further, the remaining figures illustrate updating of the magnetic map for different use cases using examples described above. In FIG. 12, GNSS measurements were available during the entire platform's route from a) to c), and shows cross sections of one component of magnetic field of two magnetic anomalies (corresponding to 725 and 726 in FIG. 7) for an increasing number of processed datasets, specifically for n=10, 20, and 30 datasets respectively. The dashed line in FIG. 12 shows the true magnetic field that was set for the example, and the solid line shows the estimate of the magnetic field according to techniques of this disclosure. It can be noticed that the estimate of magnetic field gets gradually closer and converges to the true value as the number of the datasets increases.

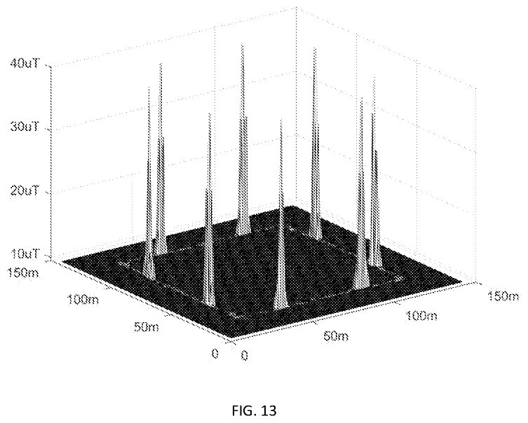

Next, FIG. 13 shows a 3D plot of a map of magnetic anomalies for one component of magnetic field after processing of 30 datasets. It can be noticed that the estimated map of magnetic anomalies in FIG. 13 is close to the true map shown in FIG. 7.

A still further example illustrates the possibility or proposing method to create magnetic map for areas where GNSS positions are unavailable, such as narrow urban canyons, tunnels, and underground parking garages. All such areas have the mutual feature that the platform's trajectory partly comes though areas where GNSS positions are available, whereas some other parts suffer from obstruction of GNSS satellites. An example of such situation is when a car was driving outdoors with available GNSS and then passed through a tunnel or finished its trajectory in an underground parking garage without GNSS.

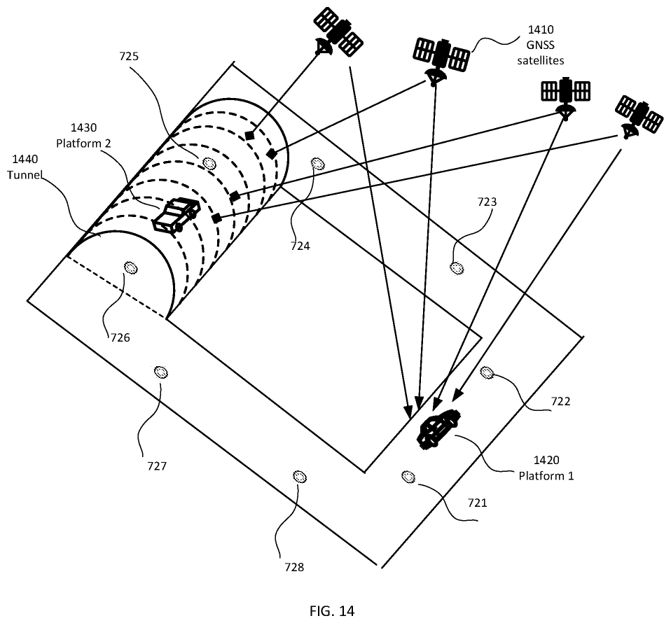

Another use case when such situation can occur is a pedestrian that walked outdoors and then enters an indoor area, for example, a shopping mall. The whole optimization while determining the second set of platform poses with use of magnetic constraints including all parts of the trajectory allows the gradual, iterative dataset processing to estimate magnetic field values in such areas without GNSS positions. FIG. 14 shows magnetic anomalies 721-728 of FIG. 7 as contour lines. In the example, it is assumed that signals of GNSS satellites 1410 can reach the platform 1 (1420) but GNSS signals are unreachable for platform 2 (1430) when platform 2 travels through a tunnel 1440 where magnetic anomalies 725 and 726 are located. Therefore, GNSS is available for the platforms travelling through magnetic anomalies 721-724 preceding the obstructed area 1440 and for magnetic anomalies 727 and 728 following it by the platform's route so that this example illustrates a typical situation of an urban canyon or a tunnel.

Next, FIG. 15 illustrates determination of the second set of positions for this example when GNSS positions are partly unavailable. In contrast with FIG. 10, in which GNSS data was always available, FIG. 15 gives an example of determination of the second set of positions when GNSS positions shown by squares, are not available in the upper horizontal side of the squared trajectory. Despite that, magnetic constraints were determined properly, and the second set of positions was close enough to the true path to correctly update the magnetic map in GNSS shadowed area.

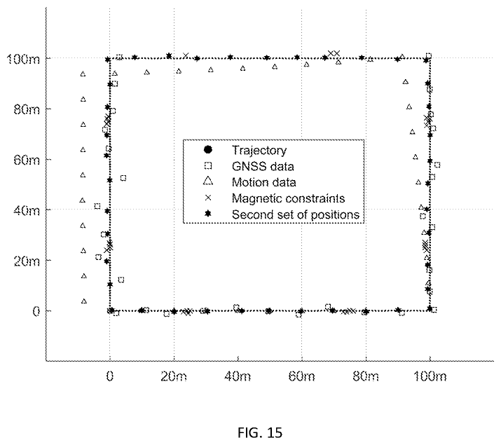

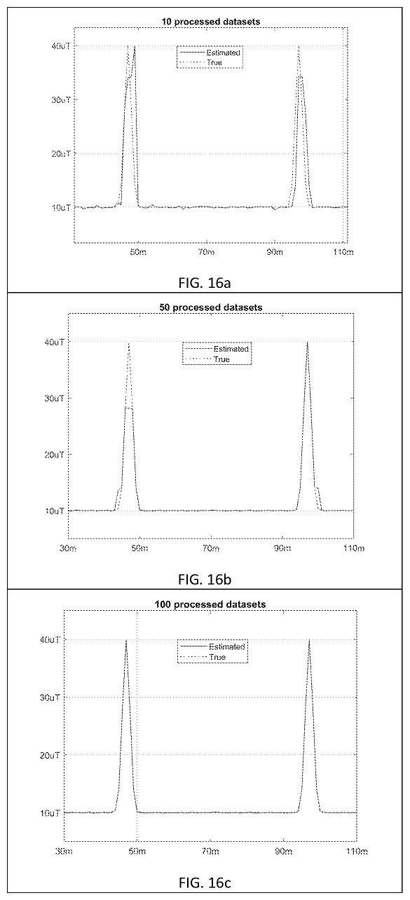

Finally, FIG. 16, from a) to c), shows cross sections of one component of magnetic map for these two magnetic anomalies in the tunnel (725 and 726) for increasing number of processed datasets, specifically for 10, 50, and 100 datasets respectively. A dashed line in FIG. 16 shows true magnetic field that was set for the simulation, and a solid line shows the estimate of magnetic map according to proposing solution. It can be noticed that the estimate of magnetic field gets closer to the true value when the number of the datasets increases.

### Additional Variations

### 2.1 Accommodating Different Magnetometer Heights

The ambient magnetic field is known to depend on height and not only on 2D position. Accordingly, the magnetic fingerprint map desirably represents the magnetic field at the same height as the magnetometer used to obtain the magnetic field measurements for a given platform. As such, this may depend on the location of the magnetometer in the vehicle. Thus, it is beneficial to employ magnetic fingerprint maps that have measurements at the appropriate height. For a ground vehicle, the magnetic fingerprint map should be at the height of magnetometer installation.

Correspondingly, in some embodiments, the motion sensor data can also include configuration parameters, such as a height of the magnetometer installation above the ground, misalignment of magnetometer axes relative to platform axes, and possibly other parameters. These configuration parameters can be determined (measured) during installation of the equipment like a magnetometer in a platform. The configuration parameters such as height of installation of the magnetometer can be, for example, sent to the server via an available wireless communication channel. Alternatively or in addition, a specific model of vehicle having known magnetometer height may be registered on the server such that the configuration parameters are saved previously then used when subsequent datasets are obtained from that platform, which may be identified by a suitable identification for example.

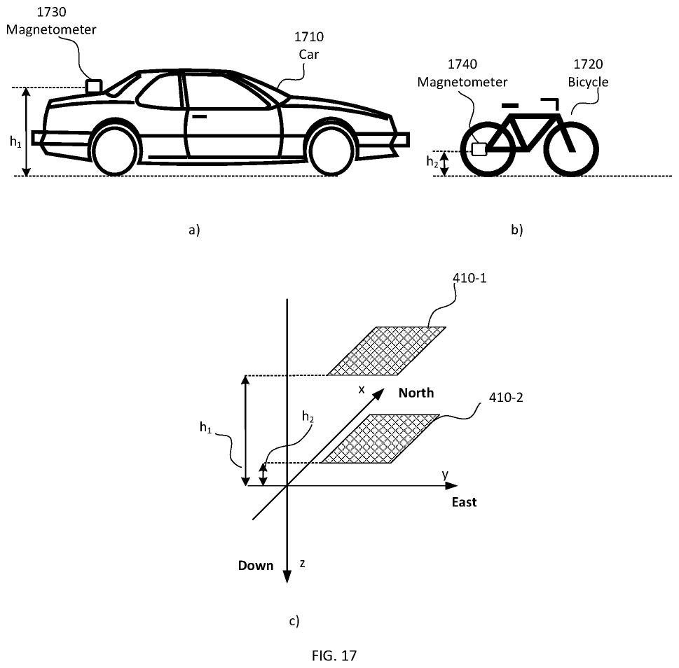

The magnetic map is created in layers, so that several layers of 2D magnetic fingerprint maps can be created, each layer featuring different height above the ground according to the height of magnetometer informed by a vehicle. This idea is illustrated by FIG. 17 (dimensions and places of installation of magnetometers in this figure are shown entirely as an illustration and do not limit any particular implementation.) Particularly, FIG. 17a shows an example of a vehicle like a car 1710 equipped with a magnetometer 1730 that is installed at height h₁ above the ground whereas FIG. 17b shows an example of a bicycle 1720 equipped with a magnetometer 1740 that is installed at a height h₂ above the ground. It can be noticed in this example that the height of the magnetometer on the car is greater than the height on the bicycle. Only two vehicles are shown as examples in FIG. 17, but the same information can be sent to the server from the plurality of the platforms in the area. The server, upon receiving magnetometer measurements from the platforms tied to the specific height of a magnetometer, groups the magnetometer measurements by height of the magnetometer above the ground. Then the server builds the magnetic map for each group as a set of 2D layers, each layer featuring different height above the ground according to the height of magnetometer informed by a vehicle. Each layer is bult separately using the described above procedure for magnetometer measurements grouped for each specific height. FIG. 17c shows an example of 2-layer magnetic map in the same NED frame as in FIG. 4a. While the magnetic map in FIG. 4a has just one layer 410, the magnetic map in FIG. 17c comprises two layers: the first layer 410-1 represents magnetic field at height h₁, which is magnetometer height on the car 1710 shown in FIG. 17a, and the second layer 410-2 represents magnetic field at height h₂, which is magnetometer height on the bicycle 1720 shown in FIG. 17b.

Further, an additional optional aspect involves interpolating the magnetic map information between the layers to derive magnetic field measurements for the environment at the magnetometer height. As will be appreciated, this allows providing a means for making a magnetic-based vehicle position determination in a greater range of circumstances as described in commonly-owned U.S. Pat. No. 11,536,571, which is hereby incorporated by reference.

### 2.2 Different State Estimation Techniques

In above description, FGO was used for fusion of different data. Instead of FGO other state estimation techniques can be used, for example, EKF or PF.

EKF is a known technique for integration of motion and GNSS data, the latter can be in a form of PVT solution (loose integration) or raw GNSS measurements (tight integration.) EKF is based on linearization of motion and measurements models, and as soon as the magnetic constraints (see paragraph 4.5) are linearizable, they can be adopted by EKF as well. Known methods such as forward-backward recursion of EKF can also be used to obtain a smoother estimate. PF does not require linearization and can be used as well as EKF.

### 2.3 Creating Other Maps

Besides the magnetic map that have been the focus of the above disclosure, other maps can be created for wireless signals of opportunity like Wi-Fi, FM radio, LTE, etc. For this purpose, the platform or portable device may be equipped with a wireless receiver that can provide RSSI level for different signal sources, like Wi-Fi access points, which may be accompanied by timestamps. Creation of a wireless map, e.g., a map of Wi-Fi signals level, is brought to binding the RSSI measurements with position of the second set of vehicle's poses determined by the proposing method.

### CONTEMPLATED EMBODIMENTS

The present disclosure describes the body frame to be x forward, y positive towards right side of the body and z axis positive downwards. It is contemplated that any body-frame definition can be used for the application of the method and apparatus described herein.

Magnetic-based indoor vehicle positioning can be combined with other positioning techniques depending upon availability for further improvement of positioning accuracy and reliability. The embodiments and techniques described above may be implemented in software as various interconnected functional blocks or distinct software modules. This is not necessary, however, and there may be cases where these functional blocks or modules are equivalently aggregated into a single logic device, program, or operation with unclear boundaries. In any event, the functional blocks and software modules implementing the embodiments described above, or features of the interface can be implemented by themselves, or in combination with other operations in either hardware or software, either within the device entirely, or in conjunction with the device and other processer enabled devices in communication with the device, such as a server.

The above disclosure details how the map of magnetic anomalies for an area can be crowdsourced using the data from thousands of vehicles driving by overlapping routes in the area. The data may also be collected using portable devices, such as smart phones or the like, that are transported by platforms, including pedestrians and vehicles. The data provided by portable devices at least comprise magnetometer measurements, GNSS measurements, and motion data measurements, and in some embodiments can include wireless and other data.

The area in which magnetic field is mapped can be entirely outdoor area, e.g., urban area, and can be partly outdoor and partly indoor area like a tunnel, or a parking garage, or, in case of a pedestrian, a shopping mall. It was demonstrated that in these cases the magnetic map is gradually (progressively) becomes more accurate as a number of datasets collected by portable devices increases.

Likewise, this disclosure demonstrates how the effect of ambiguity of in magnetic field values can be mitigated, and how the problem of different height of magnetometer installation on vehicles can be solved.

The disclosure was supported by simulation to make the explanation clearer; however, it should be obvious that the simulation example does not narrow the field of application of the proposed solution. Notably, although a few embodiments have been shown and described, it will be appreciated by those skilled in the art that various changes and modifications can be made to these embodiments without changing or departing from their scope, intent, or functionality. The terms and expressions used in the preceding specification have been used herein as terms of description and not of limitation, and there is no intention in the use of such terms and expressions of excluding equivalents of the features shown and described or portions thereof, it being recognized that the disclosure is defined and limited only by the claims that follow.

What is claimed is:

1. A method for building a magnetic map of an area, wherein the area comprises a plurality of positions and wherein the magnetic map comprises magnetic field values for the positions, the method comprising:
a) for each of a plurality of platforms traversing at least a portion of the area, obtaining magnetic field measurements from at least one magnetometer associated with each platform, available absolute navigational information, and motion sensor data from a sensor assembly associated with each platform;
b) employing the absolute navigational information and motion sensor data to determine a first set of poses for each platform;
c) obtaining information from the magnetic map for any existing magnetic field values for the first set of poses;
d) determining magnetic constraints on poses of the platform based at least in part on the obtained magnetic map information and the obtained magnetic field measurements;
e) determining a second set of poses for each platform based at least in part on the determined magnetic constraints, the obtained magnetic field measurements, absolute navigational information and motion sensor data; and
f) updating the magnetic field values of the magnetic map based at least in part on the second set of poses for each platform.

2. The method of claim 1, wherein the magnetic map further comprises covariances of the magnetic field values, further comprising updating the covariances of magnetic field values of the magnetic map based at least in part on the second set of poses for each platform.

3. The method of claim 1, wherein determining the second set comprises matching the obtained magnetic field measurements with the obtained magnetic map information using the determined magnetic constraints.

4. The method of claim 3, wherein the matching includes employing consecutive magnetic field measurements.

5. The method of claim 1, wherein determining the second set comprises employing the obtained magnetic field measurements to estimate a magnetic heading for at least some of the poses using the determined magnetic constraints.

6. The method of claim 5, wherein estimating the magnetic heading is also based on the obtained magnetic map information.

7. The method of claim 1, wherein at least one of the first set of platforms' poses and the second set of platforms' poses is determined by tightly integrating the absolute navigational information.

8. The method of claim 1, wherein updating the magnetic field values of the magnetic map is performed recursively based at least in part on a relation between covariances of the obtained magnetic map information and the obtained magnetic field measurements.

9. The method of claim 1, wherein updating the magnetic field values and covariances of the magnetic map is further based on estimated uncertainties associated with the magnetic field measurements by applying a robust estimation procedure.

10. The method of claim 1, wherein absolute navigational information is unavailable for at least one pose for at least one of the platforms.

11. The method of claim 1, wherein the at least one magnetometer and the sensor assembly associated with at least one of the plurality of platforms is integrated into a portable device conveyed by the platform and wherein the method is operable when the portable device is constrained within the platform and when the portable device is unconstrained within the platform.

12. The method of claim 11, wherein the platform conveying the portable device is at least one of a pedestrian and a vehicle.

13. The method of claim 1, further comprising determining a height of the magnetometer for at least one of the platforms, wherein updating the magnetic map information includes the determined height.

14. The method of claim 1, further comprising integrating measurements from at least one of additional source of data for determination at least one of the first and second sets of platforms' poses, wherein at least one of a plurality of platforms further comprises at least one of a wireless receiver, a camera, a lidar, and a radar, from which the measurements from the additional source of data are acquired.

15. The method of claim 1, further comprising creating a map of wireless signals based on received wireless signals and at least in part on the second set of poses for each platform, wherein at least one of a plurality of platforms further comprises a wireless receiver.

16. The method of claim 1, wherein the motion sensor data for at least one of the platforms comprises information obtained from at least one of an odometry sensor, a velocity sensor and a pressure sensor.

17. The method of claim 1, wherein the motion sensor data for at least one of the platforms comprises inertial motion sensor information.

18. The method of claim 1, further comprising at least partially initializing the magnetic map using at least one of values from a global geomagnetic model and results of a previous mapping operation.

19. A system for building a magnetic map of an area, wherein the area comprises a plurality of positions and wherein the magnetic map comprises magnetic field values for the positions, comprising:
a) a plurality of platforms traversing at least a portion of the area, wherein each platform is configured to provide magnetic field measurements from at least one magnetometer associated with each platform, available absolute navigational information, and motion sensor data from a sensor assembly associated with each platform;
b) at least one remote memory to store the magnetic map; and
c) at least one remote processor operative to:
i) obtain a determined a first set of poses for each platform, wherein the first set is determined by employing the absolute navigational information and motion sensor data;
ii) obtain information from the magnetic map for any existing magnetic field values for the first set of poses;
iii) determine magnetic constraints on poses of the platform based at least in part on the obtained magnetic map information and the obtained magnetic field measurements;
iv) obtain a second set of poses for each platform based at least in part on determined magnetic constraints, the obtained magnetic field measurements, absolute navigational information and motion sensor data; and
v) update the magnetic field values of the magnetic map based at least in part on the second set for each platform.

20. The system of claim 19, wherein at least one of the first set of poses, the second set of poses and the magnetic constraints are determined by at least one of the platforms.

21. The system of claim 19, wherein at least one of the first set of poses, the second set of poses and the magnetic constraints are determined by the at least one remote processor.

22. The system of claim 19, wherein at least one of the at least one remote processor and at least one remote memory are further configured for building and storing a map of wireless signals.

23. The system of claim 19, wherein the at least one remote processor is further configured to obtain a height of the magnetometer for at least one of the platforms, wherein updating the magnetic map information includes the obtained height.

24. The system of claim 19, wherein the magnetic map further comprises covariances of the magnetic field values, wherein the at least one remote processor is further configured to update the covariances of magnetic field values of the magnetic map based at least in part on the second set of poses for each platform.

25. A non-transitory computer readable storage medium comprising instructions embodied thereon for causing at least one processor to perform a method for building a magnetic map of an area, wherein the area comprises a plurality of positions and wherein the magnetic map comprises magnetic field values for the positions, the method comprising:
a) obtaining a determined a first set of poses for a plurality of platforms traversing at least a portion of the area, wherein each platform is configured to provide magnetic field measurements from at least one magnetometer associated with each platform, available absolute navigational information, and motion sensor data from a sensor assembly associated with each platform and wherein the first set of platforms' poses is determined by employing the absolute navigational information and motion sensor data;
b) obtaining information from the magnetic map for any existing magnetic field values for the first set of poses;
c) determining magnetic constraints on poses of the platform based at least in part on the obtained magnetic map information and the obtained magnetic field measurements;
d) obtaining a second set of poses for each platform based at least in part on determined magnetic constraints, the obtained magnetic field measurements, absolute navigational information and motion sensor data; and
e) updating the magnetic field values of the magnetic map based at least in part on the second set for each platform.

26. The non-transitory computer readable storage medium of claim 25, wherein the magnetic map further comprises covariances of the magnetic field values and wherein the method performed by the at least one processor further comprises updating the covariances of magnetic field values of the magnetic map based at least in part on the second set for each platform.
